(19) United States
(12) Patent Application Publication
(10) Pub. No.: US 2021/0395154 A1
(43) Pub. Date: Dec. 23, 2021

(54) CONDUCTIVE CERAMIC HONEYCOMBS WITH RESISTIVE HEATING CAPABILITY AND METHODS OF MAKING THE SAME

(71) Applicant: CORNING INCORPORATED, Corning, NY (US)

(72) Inventors: Catherine Michelle Burdick, Lindley, NY (US); Kishor Purushottam Gadkaree, Painted Post, NY (US); Andrew Fleitz Husted, Wellsburg, NY (US); Rahul Suryakant Kadam, Big Flats, NY (US)

(21) Appl. No.: 17/293,288

(22) PCT Filed: Nov. 14, 2019
(86) PCT No.: PCT/US2019/061482

§ 371 Date: May 12, 2021

Related U.S. Application Data
(60) Provisional application No. 62/767,694, filed on Nov. 15, 2018.

(51) Int. Cl. C04B 38/00; C04B 35/565

(52) U.S. Cl. CPC C04B 38/0009; C04B 2111/94; C04B 38/0054; C04B 35/565

(57) ABSTRACT

electrically conductive honeycomb body that includes a porous honeycomb structure including a plurality of intersecting porous walls arranged to provide a matrix of cells, the porous walls including wall surfaces that define a plurality of channels extending from an inlet end to an outlet end of the structure. The porous walls include ceramic composite material that includes at least one carbide phase and at least one silicide phase, each carbide and silicide phase including one or more metals selected from the group consisting of Si, Mo, Ti, Zr and W.

This application claims the benefit of priority under 35 U.S.C. § 119 of U.S. Provisional Application No. 62/767,694 filed on Nov. 15, 2018, the content of which is incorporated herein by reference in its entirety.

### FIELD OF THE DISCLOSURE

The present disclosure relates generally to conductive ceramic honeycombs with electrically resistive heating capability, including ceramic honeycombs that are useful in treatment of organic compounds in a flow stream.

### BACKGROUND

Ceramic honeycombs have been utilized extensively in the automotive industry for pollution and emission control.

Accordingly, there is a need for honeycombs that offer improved efficiencies in exhaust treatment, along with methods of making these honeycombs.

### SUMMARY

An aspect of the disclosure pertains to a conductive ceramic honeycomb body that comprises: a porous honeycomb structure comprising a plurality of intersecting porous walls arranged to provide a matrix of cells, the porous walls comprising wall surfaces that define a plurality of channels extending from an inlet end to an outlet end of the structure. The porous walls are comprised of a ceramic composite material that comprises at least one carbide phase and at least one silicide phase, each carbide and silicide phase comprising one or more metals selected from the group consisting of Si, Mo, Ti, Zr and W.

An aspect of the disclosure pertains to a method of making a conductive ceramic honeycomb that comprises: mixing a plurality of ingredients together into a mixture, the ingredients comprising (a) a metal powder selected from the group consisting of Mo, Ti, Zr and W metal powder, (b) a silicon (Si) metal powder, (c) a carbon precursor and (d) a liquid vehicle; extruding the mixture into a green honeycomb body; drying the green honeycomb body in air from about 50° C. to about 200° C.; carbonizing the green honeycomb body in an inert atmosphere from about 300° C. to about 900° C.; and firing the green honeycomb body in an inert atmosphere from about 1400° C. to about 1800° C. to form an electrically conductive honeycomb body, the honeycomb body comprising a plurality of intersecting porous walls arranged to provide a matrix of cells, the porous walls comprising wall surfaces that define a plurality of channels extending from an inlet end to an outlet end of the structure. Further, the porous walls are comprised of a ceramic composite material that comprises at least one carbide phase and at least one silicide phase, each carbide and silicide phase comprising one or more metals selected from the group consisting of Si, Mo, Ti, Zr and W.

According to aspects of these disclosures, the porous walls of the honeycomb body have an electrical conductivity from about 1 S/cm to about 5000 S/cm. The porous walls can comprise a median pore size from about 1 μm to about 10 μm. The porous walls can also comprise a median porosity from about 35% to about 70%. The porous walls may also have a pore volume from about 0.1 ml/g to about 0.5 ml/g. In addition, the porous walls can be substantially devoid of free metals, and in particular, free silicon metal. By “substantially devoid” as used herein, it is meant that the composition of an article, mixture, or composite contains less than 0.5 wt % of a specified material (e.g., free silicon metal), or more preferably less than 0.1 wt %. In some embodiments, the composition comprises essentially none of the specified material, or is even devoid of the specified material (e.g., the porous walls preferably contain essentially no free silicon metal, and more preferably contain no free silicon metal).

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the disclosure as it is claimed.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following aspects.

### BRIEF DESCRIPTION OF THE DRAWINGS

These and other features, aspects and advantages of the present disclosure are better understood when the following detailed description of the disclosure is read with reference to the accompanying drawings, in which:

FIG. 1 is a perspective, schematic view of a catalytic remediation or other treatment system (e.g., for gasoline and diesel engine exhaust gases) with a conductive ceramic honeycomb according to an aspect of the disclosure;

FIG. 1A is a top-down, plan view of the system and conductive ceramic honeycomb depicted in FIG. 1;

FIG. 1B is an enlarged, top-down, schematic view of a conductive ceramic honeycomb depicted in FIG. 1

FIG. 1C is a perspective, schematic view of a catalytic remediation or other treatment system (e.g., for gasoline and diesel engine exhaust gases);

FIG. 2 is a schematic flow chart of a method of making a conductive ceramic honeycomb according to an aspect of the disclosure;

FIGS. 3A-3C are x-ray diffraction (XRD) plots of exemplary conductive ceramic honeycomb compositions, as prepared according to a method of making of making a ceramic conductive honeycomb, according to embodiments of the disclosure;

FIG. 4 is a pore size distribution plot of an exemplary conductive ceramic honeycomb composition, as prepared according to a method of making a ceramic honeycomb, according to an embodiment of the disclosure;

FIG. 5 is a plot of electrical conductivity vs. mole fraction of molybdenum for exemplary conductive ceramic compositions comprising molybdenum metal powder, silicon metal powder and carbon precursors, as prepared and after 100 hours of exposure to air at 1000° C., according to embodiments of the disclosure;

FIGS. 6-10A are top-down schematic views of treatment systems comprising a conductive ceramic honeycomb body according to various embodiments of the disclosure;

FIG. 10B is a side view of the treatment system of FIG. 10B;

FIGS. 11-13 are top-down schematic views of aftertreatment systems comprising non-honeycomb conductive ceramic bodies according to various embodiments of the disclosure;

FIG. 14A is a perspective view of an aftertreatment system comprising non-honeycomb conductive ceramic bodies according to some embodiments of the disclosure; and

FIG. 14B is a top-down view of the aftertreatment system of claim 14A.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

Aspects of the disclosure generally relate to conductive ceramic honeycombs with electrically resistive heating capability that are useful in the removal of compounds from gasoline and diesel engine exhaust, such as carbon dioxide. These ceramic honeycombs can be directly heated by passing a current through their surfaces by virtue of the resistance and relatively high electrical conductivity of their ceramic composite material (e.g., as compared to cordierite, a material employed in conventional honeycomb structures). Advantageously, these ceramic composites possess carbide and silicide phases that are formed in situ during processing, which results in a fine dispersion of these phases and porosity—attributes that drive electrical conductivity and treatment efficacy. Another advantage of these ceramic honeycombs is that they are comprised of ceramic composite materials with very high oxidation resistance, suitable for use in high temperature exhaust streams. For example, embodiments of these ceramic honeycombs are substantially free of silicon metal, which helps ensure that the honeycomb is resistant to oxidation over its lifetime exposure to an oxidative, exhaust stream.

Aspects of the disclosure are also directed to methods of making these conductive ceramic honeycombs. Notably, the methods employ metal powders (e.g., Si metal powder and at least one of Mo, W, Ti and Zr metal powders), along with carbon precursors. In general, however, the methods, do not rely on the use of ceramic materials as precursors. As such, the ceramic composites, as formed according to the methods, possess very fine distributions of carbide and silicide phases that are formed in situ during the carbonization and firing aspects of the methods. Consequently, the resulting ceramic composites (e.g., in ceramic honeycomb form) are produced according to the methods of the disclosure with high electrical conductivity. Further, the electrical conductivity of these ceramic composites can be controlled by controlling the composition of the metal powder and carbon precursors during the batching and mixing steps of the method.

Gases evolving from gasoline and diesel engines exhaust after combustion can include organic compounds generally considered to be harmful or undesirable. A catalytic converter assists in the treatment of these organic compounds, e.g., the removal and/or remediation of the compounds to simple and harmless compounds, thus limiting the contribution of the exhaust to environmental pollution. For example, a catalytic converter can comprise a ceramic honeycomb structure that is coated with noble precious metals as catalysts. The exhaust gases from the gasoline or diesel engine flow through the honeycomb structure over a coated catalytic bed to undergo reactions to form simple harmless molecules such as O₂, N₂, CO₂ and H₂O. Two types of catalysts used in catalytic converters include an oxidation catalyst and a reduction catalyst. Some of the different metals used as the catalyst are Pt, Pd, Rh, Ce, Fe, Mn and Ni. The catalysts can convert NOₓ gases to N₂ and O₂ and CO gas to CO2. The gases evolved from the engine can be hot in temperature and transfer heat to activate the catalyst to catalyze the reactions efficiently. However, there can be a lag in the temperature increase of the catalyst during a cold start of a vehicle resulting in the catalyst not being at the required temperature for catalysis. Consequently, the temperature lag associated with a cold start can cause the escape of harmful exhaust gas compounds into the environment without being catalyzed, e.g., to smaller and harmless gases. To efficiently minimize this early escape of harmful gases from the exhaust, the porous honeycomb structures disclosed herein comprise ceramic composite materials that can be heated rapidly through electrical conduction of electrical current, e.g., within the first few seconds of the engine ignition.

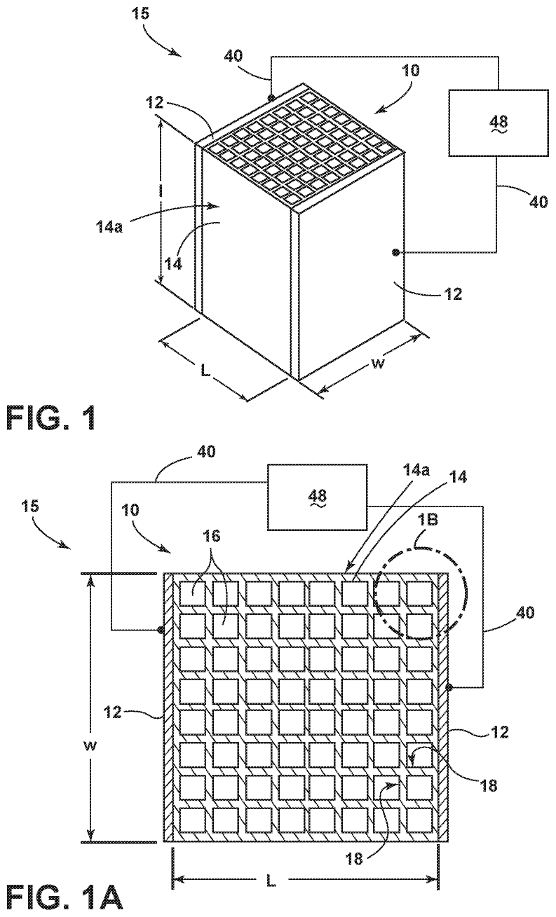

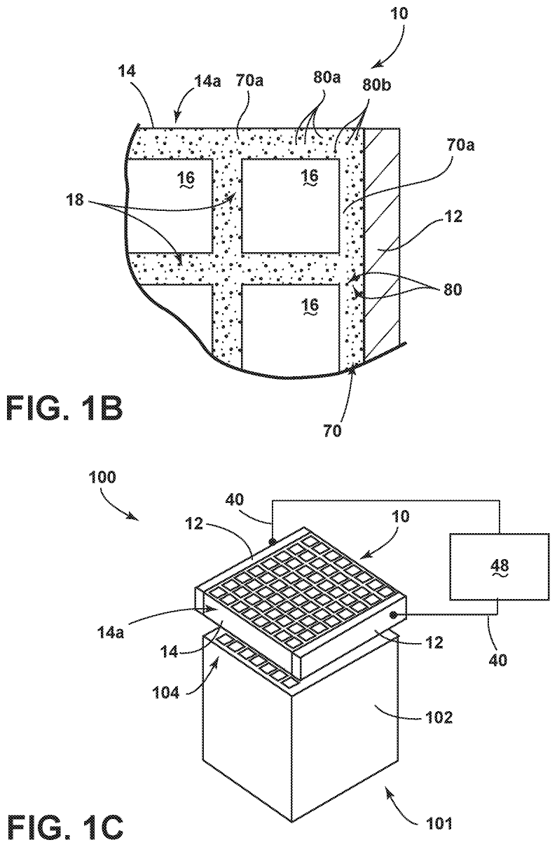

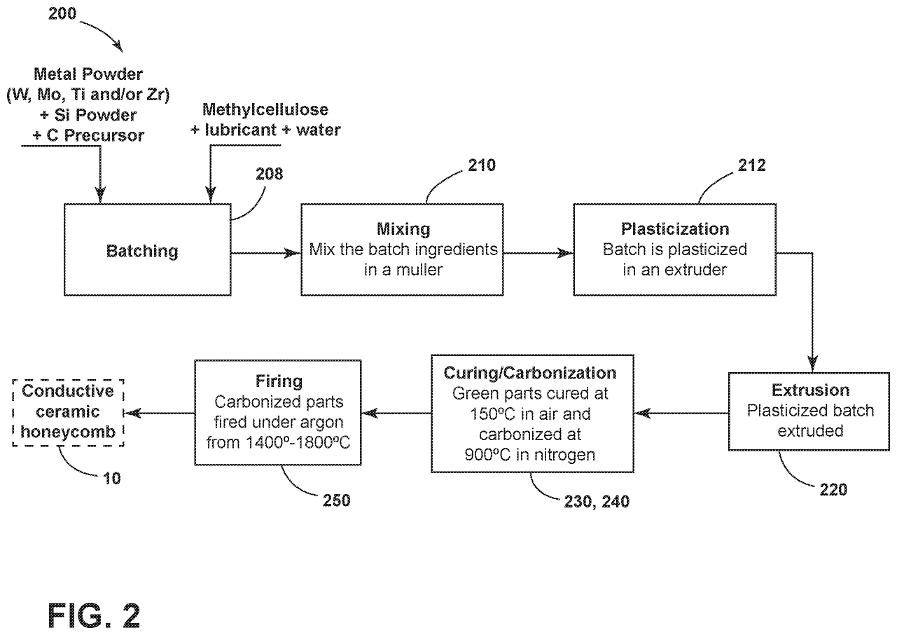

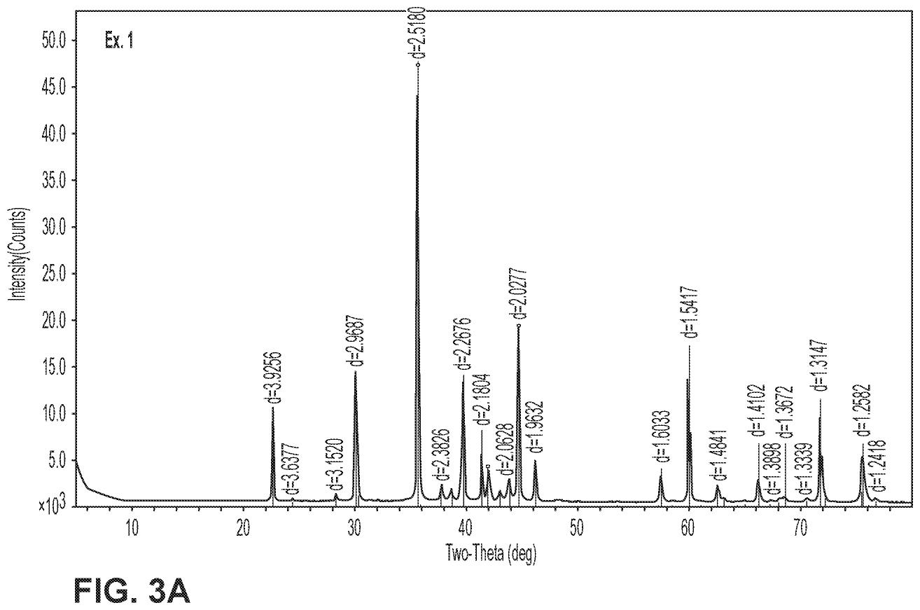

Referring to FIGS. 1, 1A and 1B, a conductive ceramic honeycomb 10 (also referred herein as a porous honeycomb body 10) is depicted in schematic form within a treatment system 15, e.g., a catalytic remediation system for gasoline and diesel engine exhaust gases. The honeycomb 10 comprises a ceramic composite 14a in the form of a porous honeycomb structure 14. As depicted in FIG. 1, the porous honeycomb structure 14 can be defined by a length, l, width, w, and a distance, L, between two sides 12, which can be arranged, for example, as electrodes or other electrically conductive members to assist in conducting a flow of electricity through the ceramic composite 14a of the honeycomb structure 14. The sides 12 can be formed from a material that differs from the ceramic composite 14a, such as a metal or other highly conductive material. Further, the porous honeycomb structure 14 comprises one or more cells 16, or channels, that are defined by one or more porous walls 18 (see FIG. 1A). In addition, the ceramic composite 14a comprises at least one carbide phase 70 and at least one silicide phase 80 different than the carbide phase 70 (see FIG. 1B), each of which can be substantially dispersed within the composite 14a. The carbide phase(s) 70 and the silicide phase(s) 80 each comprises a metal selected from the group consisting of Si, Mo, Ti, Zr and W. In the exemplary embodiment depicted in FIG. 1B, the at least one carbide phase 70 can be silicon carbide 70a and the at least one silicide 80 can be a metal di-silicide 80a and a metal tri-silicide 80b, e.g., MoSi₂ and Mo₅Si₃, respectively.

As shown in FIG. 1C, the honeycomb body 10 can be arranged in an aftertreatment system 100 in which the honeycomb body 10 is used in conjunction with a separate aftertreatment device 101, which also comprises a honeycomb body 102 having a honeycomb structure 104 made from a porous ceramic material. The honeycomb structure 104 comprises cells and intersecting walls akin to the cells 16 and walls 18 described with respect to the honeycomb 10. The aftertreatment device 101 can be or can comprise at least a portion of a catalytic converter assembly (e.g., its walls loaded with a catalytic material that treats one or more pollutants in a fluid stream), a particulate filter (e.g., having alternatingly plugged channels at opposite ends), and/or a partial filter (having both plugged and unplugged channels).

At least one of the honeycomb body 10 and the aftertreatment device 101 are loaded with a catalytic material, e.g., both the honeycomb body 10 and the aftertreatment device 101 are loaded with a catalytic material or only one of the honeycomb body 10 or the aftertreatment device 101 are so loaded. In the embodiment of FIG. 1C, the axial length, l, of the honeycomb body 10 is short relative to the width, w, and distance, L (in contrast to the embodiment of FIG. 1, in which the axial length, l, is relatively longer than the width, w, and the distance, L). In this way, the thermal mass of the honeycomb body 10 can be reduced (in comparison to an axially longer body), to enable the walls 18 of the honeycomb body 10 to heat up quickly. As a result, the honeycomb body 10 can effectively form a heater for providing heat to catalytic material in the system 100 (the catalytic material carried by the honeycomb body 10 and/or by the honeycomb body 102). If the honeycomb body 10 does not carry any catalytic material, then the heat generated in the walls 18 can indirectly heat the catalytic material by positioning the honeycomb body 10 upstream of the aftertreatment device 101 in order to heat the fluid stream, which then heats and activates the catalytic material carried by the honeycomb body 102 as the fluid stream passes through the channels of the aftertreatment device 101.

The porous ceramic material of the honeycomb body 102 can comprise one or more of cordierite, aluminum titanate, silicon carbide, or other ceramic materials. The material of the honeycomb body 102 can be different than the ceramic composite 14a, and need not be electrically conductive. Similarly, the shape and dimensions of the honeycomb body 102 or its features (e.g., cells and walls), can also differ from the corresponding shape and dimensions of the honeycomb body 10 and its features (e.g., the cells 16 and walls 18).

As also shown in FIGS. 1, and 1A-1C, the temperature of the ceramic honeycomb 10, including the porous honeycomb structure 14, can be controlled by conduction of an electrical current and the resistance associated with its conduction. In certain implementations, sides 12 of the ceramic honeycomb 10 are conductive, and connected to leads 40. Further, these leads 40 are connected to an electrical power supply 48. Various approaches can be employed to control the voltage of the power supply 48 in a time-dependent manner to effect temperature control of the ceramic honeycomb 10 through resistive heating via passage of electrical current through the leads 40 and the sides 12 of the porous honeycomb structure 14. Depending on the arrangement of the ceramic honeycomb 10, sides 12, leads 40, power supply 48, and other factors, the electrical conductivity of the honeycomb 10, and its porous honeycomb structure 14, can be from about 1 S/cm to about 5000 S/cm, from about 5 S/cm to about 4000 S/cm, from about 10 S/cm to about 3000 S/Cm, and all electrical conductivity values between these ranges.

As used herein in connection with the porous honeycomb structure 14 depicted in FIGS. 1, and 1A-1C, the term “porous honeycomb structure” is a shaped body comprising inner passageways, such as straight or serpentine channels and/or porous networks that would permit the flow of a fluid stream through the body, e.g., the ceramic composite 14a of the honeycomb structure 14. Further, the porous honeycomb structure 14 can comprise a dimension in a flow-through direction of at least 1 cm, at least 2 cm, at least 3 cm, at least 4 cm, at least 5 cm, at least 6 cm, at least 7 cm, at least 8 cm, at least 9 cm, at least 10 cm, or from 1 cm to 1 m, from the inlet end to the outlet end.

In some aspects of the disclosure, the porous honeycomb structure 14 has a honeycomb structure comprising an inlet end, an outlet end, and inner channels extending from the inlet end to the outlet end. In one embodiment, the honeycomb comprises a multiplicity of cells extending from the inlet end to the outlet end, the cells being defined by intersecting cell walls, e.g., cell walls 18. In one embodiment, the cells at the inlet and outlet ends are open, or unplugged. The honeycomb structure could optionally comprise one or more selectively plugged honeycomb structure cell ends to provide a wall flow-through structure that allows for more intimate contact between the cell walls and the fluid stream (e.g., the exhaust stream that includes gases and/or particulates from gasoline and diesel engines).

In an embodiment of the disclosure, the porous honeycomb structure 14, as depicted in exemplary form in FIG. 1, includes a surface having a surface area of 100 m²/g or more, 200 m²/g or more, 300 m²/g or more, 400 m²/g or more, or 500 m²/g or more.

In another embodiment of the conductive ceramic honeycomb 10 depicted in FIGS. 1, 1A and 1B, the porous honeycomb structure 14 comprises a median pore size (i.e., the median of a population of longest dimension or diameter of pores) in the range of from about 0.5 μm to about 20 μm, about 1 μm to about 10 μm, about 2 μm to about 10 μm, and all pore size values between these pore sizes.

In a further implementation of the conductive ceramic honeycomb 10 depicted in FIGS. 1, 1A and 1B, the porous honeycomb structure 14 can have a median porosity (i.e., the median of a population of porosity measurements of one or more honeycomb structures 14) from about 35% to about 70%, from about 40% to about 70%, from about 45% to about 70%, from about 50% to about 70%, and all porosities between these porosity levels. According to a further implementation of the ceramic honeycomb 10, the porous honeycomb structure 14 can include a pore volume from about from about 0.1 ml/g to about 0.6 ml/g, from about 0.1 ml/g to about 0.5 ml/g, 0.15 ml/g to about 0.5 ml/g, from about 0.2 ml to about 0.5 ml/g, and all pore volumes between these pore volume levels. In some implementations of the honeycomb 10, the pores of the porous honeycomb structure 14 may create “interconnecting porosity,” defined herein as being characterized by pores which connect into and/or intersect other pores to create a tortuous network of porosity within the honeycomb structure 14.

Further, the porous honeycomb structure 14 depicted in FIGS. 1, 1A and 1B can be characterized by a surface area available for contact with a metal catalyst (not shown). In general, as the cell density of the porous honeycomb structure 14 increases, the surface area available for contact with the metal catalyst also increases. In another embodiment, the porous honeycomb structure 14 can be characterized by a cell density ranging from about 6 cells per square inch (“cpsi”) to about 1200 cpsi. In another implementation, the cell density of the porous honeycomb structure 14 can range from about 50 cpsi to about 900 cpsi. Further, certain implementations of the porous honeycomb structure 14 can be characterized by a cell density from about 100 cpsi to about 600 cpsi.

According to another aspect, the porous honeycomb structure 14, as depicted in exemplary form in FIG. 1, can be characterized with at least one cell wall 18 having a thickness that ranges from about 0.001 inches to about 0.050 inches. Other embodiments of the porous honeycomb structure 14 can be characterized with at least one cell wall 18 having a thickness that ranges from about 0.002 inches to about 0.040 inches. More generally, increases to cell density and wall thickness of the porous honeycomb structure 14 result in higher bulk density levels and adsorbent capacity. In embodiments, porous honeycomb structure 14 includes a geometric surface area from about 10 to about 60 squared centimeters per cubic centimeter (cm²/cm³) of structure, or about 20 cm²/cm³ to about 50 cm²/cm³, or even from about 20 cm²/cm³ to about 30 cm²/cm³.

According to another implementation, the porous honeycomb structure 14 of the conductive ceramic honeycomb 10 depicted in FIGS. 1, 1A and 1B, according to aspects of the disclosure, can also be characterized by a specific surface area as measured by a Brunauer-Emmett-Teller (“BET”) method according to standard principles understood in the field of specific surface area measurement methodology. According to an embodiment, the honeycomb 10 can be characterized by a specific surface area from about 50 m²/g to about 1000 m²/g. In some aspects, the specific surface area of the honeycomb 10 is from about 100 m²/g to about 600 m²/g. In another aspect, the specific surface area of the honeycomb 10 is from about 100 m²/g to about 200 m²/g. In a further aspect, the specific surface area of the honeycomb 10 is from about 400 m²/g to about 600 m²/g.

Referring again to the conductive ceramic honeycomb 10, and the porous honeycomb structure 14 shown in FIG. 1B, it is evident that the ceramic composite 14a includes at least one carbide phase 70 and at least one silicide phase 80. These phases 70, 80 can be substantially dispersed within the composite 14a. In some embodiments, the carbide phase 70 is the primary phase in the sense that it forms a matrix with the at least one silicide phase 70 as second phases within the matrix. As noted earlier, the carbide phase(s) 70 and the silicide phase(s) 80 each include a metal selected from the group consisting of Si, Mo, Ti, Zr and W. In the exemplary embodiment depicted in FIG. 1B, the at least one carbide phase 70 can be silicon carbide 70a (SiC) and the at least one silicide 80 can be a metal di-silicide 80a and a metal tri-silicide 80b, e.g., MoSi₂ and Mo₅Si₃, respectively. Further, in preferred implementations of the ceramic honeycomb 10, the ceramic composite 14a is substantially devoid of free silicon (Si) metal; rather, the silicon in the composite 14a is in the form of the at least one silicide phase 80 and, in some aspects, as the at least one carbide phase 70 in the form of a silicon carbide phase 70a (SiC).

In some embodiments, the ceramic composite 14a (and/or the corresponding porous honeycomb structure 14 in this or any other example), is substantially devoid of free metals; instead, any such metals (e.g., Si, Mo, Ti, Zr, or W) are in the form of the at least one silicide 80 or the at least one carbide phase 70. In some embodiments, the ceramic composite 14a comprises essentially no free silicon metal, and in further embodiments the ceramic composite and/or honeycomb structure comprises essentially no free metals. Similar to the above, instead of being included as free metals, any metal in the composite 14a may be in the form of the at least one silicide phase 80 and/or the at least one carbide phase 70. For example, stoichiometric amounts of the components of the silicide and carbide phases, including metals, can be selected to form the silicide and/or carbide phases in situ such that the composite 14a is substantially devoid of free metal, more preferably contains essentially no free metal, or even more preferably contains no free metals.

In some embodiments, the ceramic composite 14a comprises no free silicon metal, and/or no free metals of any kind. In some embodiments, the composite or structure being substantially devoid of free metals advantageously results in a relatively more electrically conductive honeycomb body with lower thermal expansion in comparison to bodies containing free metals. In other words, minimizing the amount of free metals, and in particular free silicon metal, can be used in some embodiments to promote desirable properties of the ceramic honeycomb body 10, such as increased electrical conductivity and decreased thermal expansion, in comparison to ceramic bodies having free metals therein. That is, oxidation of free metals (e.g., upon exposure to air during use of the ceramic honeycomb body 10), can adversely affect various parameters (e.g., by decreasing thermal shock performance, decreasing electrical conductivity, and/or increasing thermal expansion). For example, free silicon metal, in particular, promotes the formation of cristobalite when oxidized, which is a very high expansion silica crystal with relatively poor electrical conductivity.

Once again referring to the conductive ceramic honeycomb 10, and the porous honeycomb structure 14 shown in FIG. 1B, in some embodiments, the ceramic composite 14a includes at least one carbide phase 70 at a volume fraction from about 40% to about 95% and at least one silicide phase 80 at a volume fraction from about 5% to about 60%. In another embodiment of the ceramic composite 14a, the at least one carbide phase 70 is at a volume fraction from about 45% to about 90% and the at least one silicide phase is at a volume fraction from about 10% to about 55%. For example, in a ceramic composite 14a in which the at least one carbide phase 70 is in the form of SiC (e.g., as a silicon carbide phase 70a) and the at least one silicide phase 80 is in the form of MoSi₂ and Mo₅Si₃ (e.g., as a metal di-silicide 80a and a metal tri-silicide 80b, respectively), the volume fraction of SiC can range from about 45% to about 90% and the total volume fraction of the MoSi₂ and Mo₅Si₃ can range from about 10% to about 55%. Referring again to the conductive honeycomb 10 shown in FIGS. 1, 1A and 1B, the porous honeycomb structure 14 can be in the form of a ceramic composite 14a that includes at least one carbide phase 70 and at least one silicide phase 80. Further, the ceramic composite 14a can be derived from a precursor mixture that includes: (a) at least one of Mo, Ti, Zr and W metal, (b) a silicon (Si) metal, and (c) a carbon precursor. The at least one of Mo, Ti, Zr and W metal can be in the form of metal powder—e.g., as Mo metal powder, Ti metal powder, Zr metal powder, W metal powder, and combinations thereof. The silicon (Si) metal can also be in the form of silicon metal powder. The carbon precursor can include water-soluble polymeric resin (e.g., phenolic resin). Other carbon precursors can include, but are not limited to, various carbon sources in the form of polymers, sugar, carbon powder, and/or natural carbon sources. The natural carbon sources can include organic flours mixed with an organic binder such as a methyl-cellulose binder, a lubricant (e.g., a LIGA sodium stearate lubricant from Peter Greven GmbH & Co.), vegetable oil or synthetic oil, and water. Exemplary organic resins include thermosetting resins and thermoplastic resins (e.g., polyvinylidene chloride, polyvinyl chloride, polyvinyl alcohol, combinations thereof, and the like). Synthetic polymer materials may also be used, such as phenolic resins or a furfural alcohol-based resin such as a furan resin. Exemplary suitable phenolic resins are resole resins such as polyphenol resins. An exemplary suitable furan liquid resin is Furcab-LP from QO Chemicals Inc., Indiana. An exemplary suitable solid resin is a solid phenolic resin, e.g., a novolac resin.

Referring again to the conductive ceramic honeycomb 10 depicted in FIGS. 1, 1A and 1B, the ceramic composites 14a, as noted above, can be derived from a mixture that one or more organic fillers or binders. Exemplary organic binders include cellulose compounds. Cellulose compounds include cellulose ethers, such as methylcellulose, ethylhydroxy ethylcellulose, hydroxybutylcellulose, hydroxybutyl methylcellulose, hydroxyethylcellulose, hydroxymethylcellulose, hydroxypropylcellulose, hydroxypropyl methylcellulose, hydroxyethyl methylcellulose, sodium carboxy methylcellulose, and mixtures thereof. An example methylcellulose binder is a METHOCEL™ A series product, sold by the Dow Chemical Company (“Dow”). Example hydroxypropyl methylcellulose binders include METHOCEL™ A4E, F, J, K series products, also sold by Dow. Binders in the METHOCEL™ 310 Series products, also sold by Dow, can also be used in the context of the invention. Dow METHOCEL™ A4M is an example binder for use with a RAM extruder. Dow METHOCEL™ F240C is an example binder for use with a twin screw extruder.

Referring once again to the conductive ceramic honeycomb 10 depicted in FIGS. 1, and 1A-1C, the ceramic composites 14a, as also noted above, can be derived from a mixture that comprises one or more lubricants or forming aids (also referred herein as a “plasticizer”). Exemplary forming aids include soaps, fatty acids, such as oleic, linoleic acid, sodium stearate, etc., polyoxyethylene stearate, etc., and combinations thereof. Other additives that can be useful for improving the extrusion and curing characteristics of a batch employed in fabricating the ceramic composite are phosphoric acid and oil. Exemplary oils include vegetable oils, petroleum oils with molecular weights from 250 to 1000, and other oils containing paraffinic, and/or aromatic, and/or alicyclic compounds. Some useful oils are 3-IN-ONE® oil from the WD-40 Company. Other useful oils can include synthetic oils based on poly alpha olefins, esters, polyalkylene glycols, polybutenes, silicones, polyphenyl ether, chlorotrifluoroethylene (“CTFE”) oils, and other commercially available oils. Vegetable oils such as sunflower oil, sesame oil, peanut oil, soybean oil, etc., are also useful forming aids in the preparation of the mixture that ultimately forms the ceramic composite 14a.

According to some embodiments of the ceramic composite 14a of the ceramic honeycomb 10 depicted in FIGS. 1, and 1A-1C, the composite can be derived from various percentages of the (a) at least one of Mo, Ti, Zr and W metal, (b) a silicon (Si) metal, and (c) a carbon precursor to obtain particular electrical conductivity levels and other properties (e.g., porosity, oxidation resistance, etc.) suitable for the application of the conductive honeycomb 10. In some implementations, the mole fraction of the at least one of Mo, Ti, Zr and W metal is from about 0.05 to about 0.5, the silicon (Si) metal is from about 0.4 to about 0.8 and the carbon (C) provided from the carbon precursor is from about 0.1 to about 0.5. In some implementations, the mole fraction of Mo metal is from about 0.05 to about 0.25, the mole fraction of silicon (Si) metal is from about 0.5 to about 0.7 and the mole fraction of carbon (C) provided from the carbon precursor is from about 0.15 to about 0.4. In some implementations, the mole fraction of Ti metal is from about 0.15 to about 0.4, the mole fraction of silicon (Si) metal is from about 0.5 to about 0.7 and the mole fraction of carbon (C) provided from the carbon precursor is from about 0.1 to about 0.2. According to some implementations of the conductive ceramic honeycomb 10 depicted in FIGS. 1, and 1A-1C, the ceramic composite 14a can be derived from a metal, silicon and carbon mixture such that the mole fractions of the (a) at least one of Mo, Ti, Zr and W metal, (b) silicon (Si) metal, and (c) carbon (C) provided from the carbon precursor are provided according to Table 1 below. Further, it should be understood that mixtures of Mo, Ti, Zr and W metal can be employed according to Table 1, with the mole fraction given by a mole fraction range representative of the amounts of the particular metals employed in the mixture. For example, a ceramic composite 14a derived from a mixture of Mo and Ti metal, Si metal and a carbon precursor can employ a mole fraction of metal (Mo and Ti) from about 0.1 to about 0.38, mole fraction of Si metal from about 0.43 to 0.70 and a mole fraction of carbon (C) provided from the carbon precursor from 0.10 to 0.35, as outlined below in Table 1.

TABLE 1

| | | | C from |
|---|---|---|---|
| | Mo/Ti/ | | the |
| | Zr/W | Si | carbon |
| | metal | metal | precursor |
| Ceramic | (mole | (mole | (mole |
| Composite | fraction | fraction | fraction |
| 14a | range) | range) | range) |
| Mo-Si-C | 0.05-0.30 | 0.45-0.75 | 0.10-0.45 |
| Ti-Si-C | 0.15-0.45 | 0.40-0.65 | 0.10-0.25 |
| Zr-Si-C | 0.05-0.30 | 0.45-0.75 | 0.10-0.45 |
| W-Si-C | 0.05-0.40 | 0.40-0.80 | 0.10-0.50 |

As noted earlier, the temperature of the conductive ceramic honeycomb 10 depicted in FIGS. 1, and 1A-1C can be controlled by conduction of an electrical current through its porous honeycomb structure 14 to effect the rate of heating of a metal catalyst and/or the substrate for the metal catalyst (e.g., the honeycomb structure 14) for higher remediation efficiency. The sides 12 of the honeycomb 10 can be configured to be electrically conductive, and connected to leads 40 and an electrical power supply 48. Further, the sides 12 of the honeycomb 10, which are configured to be conductive, are positioned so as to be able to conduct an electric current through the honeycomb, preferably in a uniform fashion. The actual positioning of the sides 12 depends on the geometry of the device. Nevertheless, the sides 12 of the honeycomb 10 are not limited to any specific type of conductor or conductor geometry. Preferably, however, the current passing from the power supply 48 through the leads 40 generates a substantially uniform heating of the conductive ceramic honeycomb 10 without a prevalence of hot spots.

The voltage and current requirements for the conductive ceramic honeycomb 10 depicted in FIGS. 1, and 1A-1C can vary depending on the application of the honeycomb. Further, the resistivity of the honeycomb 10, and its porous honeycomb structure 14, can be adjusted as desired according to the following equation:

$$ρ = \frac{R \cdot A}{L}$$

where ρ is resistivity in ohm-cm, R is resistance in ohms, A is the area of the conducting surface in cm² and L, as noted earlier, is the distance between two conducting surfaces in cm.

According to an embodiment of the conductive ceramic honeycomb 10 depicted in FIGS. 1, and 1A-1C, a conducting metal can be applied to each of the opposing sides 12 (or surfaces) of the honeycomb and porous honeycomb structure 14. As referred to herein, “opposing sides” or “opposing surfaces” of the honeycomb 10 are such that the sides or surfaces are so spaced according to the geometry of the porous honeycomb structure 14 and ceramic composite 14a such that passage of current between the conductive sides or surfaces produces a current that heats the porous honeycomb structure 14 in a substantially uniform fashion. Of course, the opposing surfaces may be at any location (including a multitude of locations) on or within the honeycomb 10 to enable substantially uniform heating of the porous honeycomb structure 14 with a current applied. Exemplary conducting materials that can be employed for the opposing sides 12 (or opposing surfaces as the case may be for a porous honeycomb structure 14 without parallel opposed sides 12) include metals and metal alloys that contain one or more of copper, silver, aluminum, zinc, nickel, lead, and tin. In some embodiments, the sides 12 are coated with one or more materials having a higher electrical conductivity than the ceramic composite 14a (e.g., a silver-containing paint or paste) to allow for a more uniform distribution of electrical current and, therefore, a more even distribution of temperature within the porous honeycomb structure 14. In addition, honeycombs with conductive sides 12 can be configured such that the sides 12 are in the form of, or otherwise comprise, a strip of conducting material on the porous honeycomb structure 14 of the honeycomb 10. If an electrode is employed to connect to the side 12 as part of the lead 40, for example, it can be applied by a pressure contact, e.g., a spring. Alternatively, in some aspects, a strip of conducting metal can be employed for this purpose and attached to the honeycomb 10 and continuous body by an electrically conductive adhesive, e.g., a silver-containing epoxy such as E-Solder® #3012 and #3022 from Von Roll USA, Inc. Further, in some embodiments, a copper coating can be deposited for this purpose by a spray metal coating approach as understood by those with ordinary skill in the field.

Without being bound by theory, the resistive heating of the conductive ceramic honeycomb 10 and porous honeycomb structure 14 is driven largely by the composition of the ceramic composite 14a, which contains at least one carbide phase 70 and at least one silicide phase 80, the combination being an electrically conductive ceramic material. Further, the fine dispersion of the silicide phase(s) 80 within the at least one carbide phase 70, as formed in situ, according to some embodiments, ensures that the conductivity of the ceramic composite 14a is high and yields substantially uniform heating capability.

In one embodiment, a sufficient temperature for exhaust remediation can comprise heating the honeycombs 10, as coated with a metal catalyst, in the range of from about 50° C. to about 700° C., including, for example, temperatures of 100° C., 150° C., 180° C., 200° C., 300° C., 400° C., 500° C., 600° C., and 700° C., including all ranges and subranges therebetween. In another embodiment, the sufficient heating temperature can be in the range derived from these values, including for example, a range from about 100° C. to about 300° C., or about 200° C. to about 500° C.

In addition, any conductive ceramic honeycombs 10, and other honeycomb structures consistent with the principles of this disclosure, may be incorporated into or used in other appropriate system environments. For example, the honeycombs 10 of the disclosure can be employed in an exhaust stream of diesel automotive engines or other process streams. More generally, any one of the above-mentioned honeycombs 10, and like-constructed honeycomb structures, can be incorporated into a system configuration where catalytic conversion of some components in the stream is desirable.

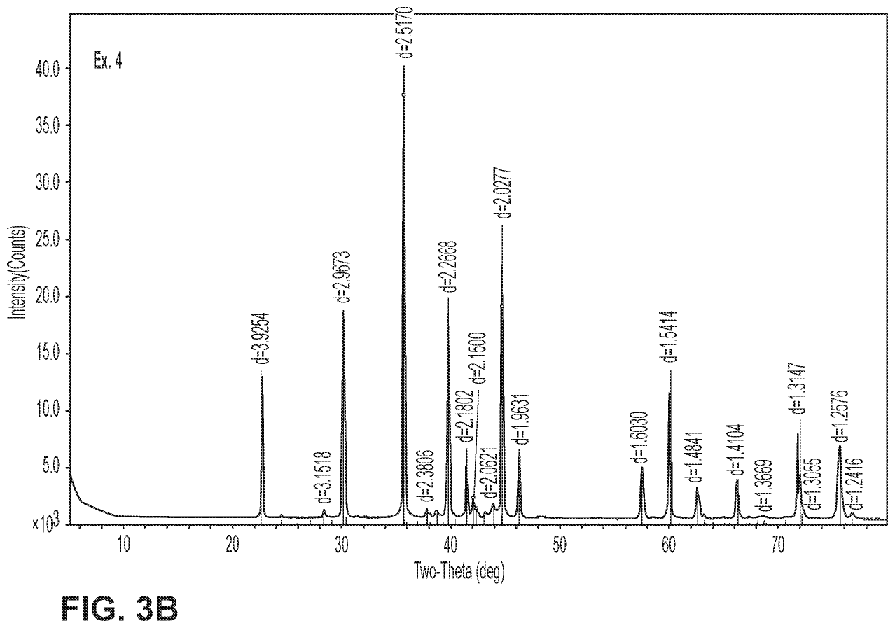

According to another embodiment of the disclosure, a method 200 of making a conductive ceramic honeycomb 10 (see also FIGS. 1-1B) is provided as shown schematically in FIG. 2. The method 200 comprises a step 208 of batching or otherwise providing a precursor batch comprising: (a) a metal powder selected from the group consisting of Mo, Ti, Zr and W metal powder, (b) a silicon (Si) metal powder and (c) a carbon precursor. In some implementations of the method 200, the mole fraction of the at least one of Mo, Ti, Zr and W metal powder is from about 0.05 to about 0.5, the silicon (Si) metal powder is from about 0.4 to about 0.8 and the carbon (C) provided from the carbon precursor is from about 0.1 to about 0.5. According to some implementations of the method 200, the batching step 208 is conducted such that the batch is derived from a metal, silicon and carbon mixture defined by the mole fractions of the (a) at least one of Mo, Ti, Zr and W metal, (b) silicon (Si) metal, and (c) carbon (C) provided from the carbon precursor that are provided according to Table 1, as noted earlier.

The method 200 further comprises a step 210 of mixing or otherwise mulling this precursor batch, e.g., in a conventional mulling apparatus as employed by those of ordinary skill in the field of the disclosure. The method 200 also comprises a step 212 of plasticizing the precursor batch, e.g., within an extrusion apparatus as employed by those of ordinary skill in the field of the disclosure. The method 200 further comprises a step 220 of extruding the batch into a green honeycomb body form, followed by a step 230 of drying or otherwise curing the green honeycomb body form in air from about 50° C. to about 200° C., preferably at about 150° C.

As also depicted in FIG. 2, the method 200 of making a conductive ceramic honeycomb 10 (see also FIGS. 1-1B) further comprises a step 240 of carbonizing the green honeycomb body form in an inert atmosphere (e.g., in N₂, Ne, Ar, He gas, and combinations thereof) from about 300° C. to about 900° C., preferably between 750° C. and 900° C. Further, the method 200 comprises a step 250 of firing the green honeycomb body form in an inert atmosphere (e.g., in He and/or Ar gas) from about 1400° C. to about 2000° C., preferably from about 1450° C. to about 1800° C., to form the conductive ceramic honeycomb 10, the honeycomb comprising a porous honeycomb structure 14. Further, the honeycomb structure 14 is a ceramic composite 14a that comprises at least one carbide phase 70 and at least one silicide phase 80, each carbide and silicide phase comprising a metal selected from the group consisting of Si, Mo, Ti, Zr and W. It should also be understood that the method 200 results in a conductive ceramic honeycomb 10, as detailed earlier in the disclosure (see FIGS. 1-1B and corresponding description).

According to embodiments of the method 200 of making a conductive ceramic honeycomb 10 depicted in FIG. 2, the steps 210, 212 and 214 of mixing, plasticizing and extruding the precursor batch of forming the mixture into a green honeycomb body form (e.g., in the form of a porous honeycomb structure 14) can be conducted according to various approaches. For example, the mixture can be formed into a shape, for example, a honeycomb, by any appropriate technique, such as by extrusion. Plasticizing and extrusion of the precursor batch (i.e., a mixture including: (a) a metal powder selected from the group consisting of Mo, Ti, Zr and W metal powder, (b) a silicon (Si) metal powder and (c) a carbon precursor) in steps 212 and 214 can be conducted by using standard extruders and extrusion equipment (e.g., a ram extruder, a single-screw extruder, a double-screw extruder, and others), along with custom dies to make porous honeycomb structures of various shapes and geometries. As noted earlier, the presence of forming aids and plasticizers in the mixture can aid in the step 210 of mixing the precursor batch.

Referring again to the method 200 of making a conductive ceramic honeycomb 10 depicted in FIG. 2, the step 230 of drying or otherwise curing the green honeycomb body form can also be conducted according to various approaches. For example, the green honeycomb body form (e.g., as comprising the precursor batch) can be heated in an oven at about 100° C. to about 200° C. for a few minutes to a few hours in ambient or an inert atmosphere to dry the mixture. To the extent that the green honeycomb body form (as formed from the precursor batch) comprises one or more organic resins, the green honeycomb body form can be cured by heating the mixture in air at atmospheric pressures and typically by heating the green form at a temperature from about 70° C. to about 200° C. for about 0.5 hours to about 24 hours. In certain embodiments of the method 200, the green honeycomb body form is heated from a low temperature to a higher temperature in stages, for example, from about 70° C., to about 90° C., to about 125° C., to about 150° C., each temperature being held for a few minutes to hours. Additionally, curing can also be accomplished by adding a curing additive such as an acid additive at room temperature, an ultraviolet (UV)-sensitive catalyst and applying UV light, and others.

After the drying and/or curing step 230, the method 200 depicted in FIG. 2 comprises a step 240 of carbonizing the carbon precursor in the green honeycomb body form. For instance, the carbon precursor in the green honeycomb body form may be carbonized by subjecting it to an elevated carbonizing temperature in an O₂-depleted atmosphere. The carbonization temperature can range from about 600° C. to about 900° C. and, in certain embodiments, it can range from about 700° C. to about 900° C. Further, the carbonizing atmosphere can be inert, primarily comprising a non-reactive gas such as N₂, Ne, Ar, and mixtures thereof. At the carbonizing temperature in an O₂-depleted atmosphere, organic substances contained in the green honeycomb body form can decompose to leave a carbonaceous residue with a high surface area.

Still referring to the method 200 of making a conductive ceramic honeycomb 10 depicted in FIG. 2, the method 200 proceeds to step 250 of firing the green honeycomb body form, e.g., after completion of the curing and carbonizing steps 230 and 240, respectively. As noted earlier, the step 250 of firing the green honeycomb body form is also conducted in an inert atmosphere. However, the non-reactive gases employed in this step should not include nitrogen, as inclusion of nitrogen would likely result in the formation of nitride phases(s), the presence of which would degrade the electrical conductivity of the resulting honeycomb. As such, step 250 of firing the green honeycomb body form can be conducted from about 1400° C. to about 2000° C., e.g., at 1450° C., 1500° C., 1550° C., 1600° C., 1650° C., 1700° C., 1750° C., 1800° C., 1850° C., 1900° C., 1950° C., 2000° C., and all firing temperatures between these temperatures. The result of step 250 is the formation of the conductive ceramic honeycomb 10, the honeycomb 10 comprising a porous honeycomb structure 14 in which the honeycomb structure 14 is a ceramic composite 14a (see also FIGS. 1-1B).

### EXAMPLES

The following examples represent certain non-limiting embodiments of the disclosure.

Various molybdenum-containing and titanium-containing conductive ceramic honeycomb examples (i.e., Examples 1-19) were prepared according to a methods of making conductive ceramic honeycombs, as noted in detail below. Each of the honeycombs is consistent with the conductive ceramic honeycombs 10 of the disclosure (see FIGS. 1-1B and corresponding description). Further, each of the methods employed to fabricated these honeycombs is consistent with the methods 200 of making conductive ceramic honeycombs of the disclosure (see FIG. 2 and corresponding description).

As noted below in Table 2, the conductive ceramic honeycombs prepared in these examples were characterized to determine their electrical conductivity (S/cm), skeletal density (g/cc), pore size (μm), porosity (%) and pore volume (ml/g). Further, the mole fractions of the metal (Mo or Ti) precursors, silicon (Si) metal, and carbon (C) provided from the carbon precursors employed to fabricate these conductive ceramic honeycombs are provided in Table 2. In addition, the molybdenum-containing conductive ceramic honeycombs (i.e., Examples 1-17) were characterized using x-ray diffraction (XRD) techniques as understood by those of ordinary skill in the field of the disclosure. The results of this characterization are provided below in Table 3A. Table 3A, in particular, details the weight percentages of the silicide (MoSi₂ and Mo₅Si₃) and carbide phases (SiC) in these conductive ceramic honeycomb structures. Further, the results in Table 3A were used to calculate volume percentages of the silicide and carbide phases in these conductive ceramic honeycomb structures, as listed below in Table 3B, using analytical techniques readily understood by those of ordinary skill in the field of this disclosure.

### Example 1

According to this example, a precursor batch was prepared by mixing the following constituents: 20.82 wt. % Mo powder, 40.95 wt. % Si powder, 7 wt. % MM1-hydroxypropyl methylcellulose A4M and 1 wt % sodium stearate (LIGA SS3 SG3 sodium stearate from Peter Greven GmbH & Co.) in a polyethylene jar. Following this step, 30.23 wt. % phenolic resin (GP® 510D50 from Georgia Pacific Chemicals) was added to the mixture and mixed in a separate polyethylene jar. Accordingly, the mole fraction ratio of Mo:Si:C for this precursor batch was 0.085:0.570:0.344, as shown below in Tables 2, 3A and 3B. The carbon fraction was calculated from experimentally measured carbon content of the resin by curing the resin at 150° C. in air, followed by carbonization in nitrogen gas at 900° C.

After batching the precursor mixture, the mixture was mulled for about 5 minutes. Next, 2 wt. % water was added to the mixture (as a super-addition) and the mixture was then mulled for an additional 20 minutes. The resulting precursor mixture was then extruded in an extruder into a porous honeycomb structure form. The extruded, green part was dried and cured at 150° C. (e.g., in a Thermo Fisher Scientific Isotemp® heating oven) to crosslink the resin and form a rigid structure. The cured rigid structure was then cut into 2 inch pieces and carbonized at 900° C. under a nitrogen atmosphere and then fired at 1800° C. under an argon atmosphere in a graphite-lined furnace. The resulting conductive ceramic honeycomb was then subjected to the following characterization: mercury porosimetry, strength testing, and XRD analysis. The honeycombs were also subjected to electrical conductivity testing by a four-probe electrical conductivity method using a Keithley® Model 2002 multimeter. The XRD pattern demonstrated the existence of a highly crystalline material with MoSi₂, Mo₅Si₃ and SiC phases. Further, the results of this characterization are provided in Tables 2, 3A and 3B below.

### Example 2

According to this example, a precursor batch was prepared by mixing the following constituents: 22.77 wt. % Mo powder, 40.72 wt. % Si powder, 7 wt. % MM1-hydroxypropyl methylcellulose A4M and 1 wt % sodium stearate (LIGA SS3 SG3 sodium stearate from Peter Greven GmbH & Co.) in a polyethylene jar. Following this step, 28.51 wt. % phenolic resin (GP® 510D50 from Georgia Pacific Chemicals) was added to the mixture and mixed in a separate polyethylene jar. Accordingly, the mole fraction ratio of Mo:Si:C for this precursor batch was 0.094:0.576:0.330, as shown below in Tables 2, 3A and 3B. Further, the resulting precursor was converted into a conductive ceramic honeycomb according to the method outlined above for Example 1. Characterization of the resulting honeycombs was also according to the techniques outlined above for Example 1, with results listed in Tables 2, 3A and 3B.

### Example 3

According to this example, a precursor batch was prepared by mixing the following constituents: 24.67 wt. % Mo powder, 40.46 wt. % Si powder, 7 wt. % MM1-hydroxypropyl methylcellulose A4M and 1 wt % sodium stearate (LIGA SS3 SG3 sodium stearate from Peter Greven GmbH & Co.) in a polyethylene jar. Following this step, 26.87 wt. % phenolic resin (GP® 510D50 from Georgia Pacific Chemicals) was added to the mixture and mixed in a separate polyethylene jar. Accordingly, the mole fraction ratio of Mo:Si:C for this precursor batch was 0.104:0.581:0.316, as shown below in Tables 2, 3A and 3B. Further, the resulting precursor was converted into a conductive ceramic honeycomb according to the method outlined above for Example 1. Characterization of the resulting honeycombs was also according to the techniques outlined above for Example 1, with results listed in Tables 2, 3A and 3B.

### Example 4

According to this example, a precursor batch was prepared by mixing the following constituents: 26.5 wt. % Mo powder, 40.23 wt. % Si powder, 7 wt. % MM1-hydroxypropyl methylcellulose A4M and 1 wt % sodium stearate (LIGA SS3 SG3 sodium stearate from Peter Greven GmbH & Co.) in a polyethylene jar. Following this step, 25.27 wt. % phenolic resin (GP® 510D50 from Georgia Pacific Chemicals) was added to the mixture and mixed in a separate polyethylene jar. Accordingly, the mole fraction ratio of Mo:Si:C for this precursor batch was 0.113:0.586:0.301, as shown below in Tables 2, 3A and 3B. Further, the resulting precursor was converted into a conductive ceramic honeycomb according to the method outlined above for Example 1. Characterization of the resulting honeycombs was also according to the techniques outlined above for Example 1, with results listed in Tables 2, 3A and 3B.

### Example 5

According to this example, a precursor batch was prepared by mixing the following constituents: 28.26 wt. % Mo powder, 40.02 wt. % Si powder, 7 wt. % MMI-hydroxypropyl methylcellulose A4M and 1 wt % sodium stearate (LIGA SS3 SG3 sodium stearate from Peter Greven GmbH & Co.) in a polyethylene jar. Following this step, 23.72 wt. % phenolic resin (GP® 510D50 from Georgia Pacific Chemicals) was added to the mixture and mixed in a separate polyethylene jar. Accordingly, the mole fraction ratio of Mo:Si:C for this precursor batch was 0.122:0.591:0.287, as shown below in Tables 2, 3A and 3B. Further, the resulting precursor was converted into a conductive ceramic honeycomb according to the method outlined above for Example 1. Characterization of the resulting honeycombs was also according to the techniques outlined above for Example 1, with results listed in Tables 2, 3A and 3B.

### Example 6

According to this example, a precursor batch was prepared by mixing the following constituents: 30.0 wt. % Mo powder, 39.78 wt. % Si powder, 7 wt. % MM1-hydroxypropyl methylcellulose A4M and 1 wt % sodium stearate (LIGA SS3 SG3 sodium stearate from Peter Greven GmbH & Co.) in a polyethylene jar. Following this step, 22.22 wt. % phenolic resin (GP® 510D50 from Georgia Pacific Chemicals) was added to the mixture and mixed in a separate polyethylene jar. Accordingly, the mole fraction ratio of Mo:Si:C for this precursor batch was 0.132:0.596:0.272, as shown below in Tables 2, 3A and 3B. Further, the resulting precursor was converted into a conductive ceramic honeycomb according to the method outlined above for Example 1. Characterization of the resulting honeycombs was also according to the techniques outlined above for Example 1, with results listed in Tables 2, 3A and 3B.

### Example 7

According to this example, a precursor batch was prepared by mixing the following constituents: 31.66 wt. % Mo powder, 39.56 wt. % Si powder, 7 wt. % MM1-hydroxypropyl methylcellulose A4M and 1 wt % sodium stearate (LIGA SS3 SG3 sodium stearate from Peter Greven GmbH & Co.) in a polyethylene jar. Following this step, 20.78 wt. % phenolic resin (GP® 510D50 from Georgia Pacific Chemicals) was added to the mixture and mixed in a separate polyethylene jar. Accordingly, the mole fraction ratio of Mo:Si:C for this precursor batch was 0.141:0.601:0.258, as shown below in Tables 2, 3A and 3B. Further, the resulting precursor was converted into a conductive ceramic honeycomb according to the method outlined above for Example 1. Characterization of the resulting honeycombs was also according to the techniques outlined above for Example 1, with results listed in Tables 2, 3A and 3B.

### Example 8

According to this example, a precursor batch was prepared by mixing the following constituents: 33.28 wt. % Mo powder, 39.36 wt. % Si powder, 7 wt. % MM1-hydroxypropyl methylcellulose A4M and 1 wt % sodium stearate (LIGA SS3 SG3 sodium stearate from Peter Greven GmbH & Co.) in a polyethylene jar. Following this step, 19.36 wt. % phenolic resin (GP® 510D50 from Georgia Pacific Chemicals) was added to the mixture and mixed in a separate polyethylene jar. Accordingly, the mole fraction ratio of Mo:Si:C for this precursor batch was 0.150:0.606:0.244, as shown below in Tables 2, 3A and 3B. Further, the resulting precursor was converted into a conductive ceramic honeycomb according to the method outlined above for Example 1. Characterization of the resulting honeycombs was also according to the techniques outlined above for Example 1, with results listed in Tables 2, 3A and 3B.

### Example 9

According to this example, a precursor batch was prepared by mixing the following constituents: 34.86 wt. % Mo powder, 39.16 wt. % Si powder, 7 wt. % MM1-hydroxypropyl methylcellulose A4M and 1 wt % sodium stearate (LIGA SS3 SG3 sodium stearate from Peter Greven GmbH & Co.) in a polyethylene jar. Following this step, 17.98 wt. % phenolic resin (GP® 510D50 from Georgia Pacific Chemicals) was added to the mixture and mixed in a separate polyethylene jar. Accordingly, the mole fraction ratio of Mo:Si:C for this precursor batch was 0.159:0.611:0.230, as shown below in Tables 2, 3A and 3B. Further, the resulting precursor was converted into a conductive ceramic honeycomb according to the method outlined above for Example 1. Characterization of the resulting honeycombs was also according to the techniques outlined above for Example 1, with results listed in Tables 2, 3A and 3B.

### Example 10

According to this example, a precursor batch was prepared by mixing the following constituents: 36.39 wt. % Mo powder, 38.96 wt. % Si powder, 7 wt. % MM1-hydroxypropyl methylcellulose A4M and 1 wt % sodium stearate (LIGA SS3 SG3 sodium stearate from Peter Greven GmbH & Co.) in a polyethylene jar. Following this step, 16.65 wt. % phenolic resin (GP® 510D50 from Georgia Pacific Chemicals) was added to the mixture and mixed in a separate polyethylene jar. Accordingly, the mole fraction ratio of Mo:Si:C for this precursor batch was 0.169:0.616:0.215, as shown below in Tables 2, 3A and 3B. Further, the resulting precursor was converted into a conductive ceramic honeycomb according to the method outlined above for Example 1. Characterization of the resulting honeycombs was also according to the techniques outlined above for Example 1, with results listed in Tables 2, 3A and 3B.

### Example 11

According to this example, a precursor batch was prepared by mixing the following constituents: 38.81 wt. % Mo powder, 38.52 wt. % Si powder, 7 wt. % MM1-hydroxypropyl methylcellulose A4M and 1 wt % sodium stearate (LIGA SS3 SG3 sodium stearate from Peter Greven GmbH & Co.) in a polyethylene jar. Following this step, 14.67 wt. % phenolic resin (GP® 510D50 from Georgia Pacific Chemicals) was added to the mixture and mixed in a separate polyethylene jar. Accordingly, the mole fraction ratio of Mo:Si:C for this precursor batch was 0.184:0.622:0.194, as shown below in Tables 2, 3A and 3B. Further, the resulting precursor was converted into a conductive ceramic honeycomb according to the method outlined above for Example 1. Characterization of the resulting honeycombs was also according to the techniques outlined above for Example 1, with results listed in Tables 2, 3A and 3B.

### Example 12

According to this example, a precursor batch was prepared by mixing the following constituents: 38.52 wt. % Mo powder, 38.94 wt. % Si powder, 7 wt. % MM1-hydroxypropyl methylcellulose A4M and 1 wt % sodium stearate (LIGA SS3 SG3 sodium stearate from Peter Greven GmbH & Co.) in a polyethylene jar. Following this step, 14.54 wt. % phenolic resin (GP® 510D50 from Georgia Pacific Chemicals) was added to the mixture and mixed in a separate polyethylene jar. Accordingly, the mole fraction ratio of Mo:Si:C for this precursor batch was 0.182:0.627:0.192, as shown below in Tables 2, 3A and 3B. Further, the resulting precursor was converted into a conductive ceramic honeycomb according to the method outlined above for Example 1. Characterization of the resulting honeycombs was also according to the techniques outlined above for Example 1, with results listed in Tables 2, 3A and 3B.

### Example 13

According to this example, a precursor batch was prepared by mixing the following constituents: 26.92 wt. % Mo powder, 42.42 wt. % Si powder, 7 wt. % MM1-hydroxypropyl methylcellulose A4M and 1 wt % sodium stearate (LIGA SS3 SG3 sodium stearate from Peter Greven GmbH & Co.) in a polyethylene jar. Following this step, 25.66 wt. % phenolic resin (GP® 510D50 from Georgia Pacific Chemicals) was added to the mixture and mixed in a separate polyethylene jar. Accordingly, the mole fraction ratio of Mo:Si:C for this precursor batch was 0.111:0.595:0.295, as shown below in Tables 2, 3A and 3B. Further, the resulting precursor was converted into a conductive ceramic honeycomb according to the method outlined above for Example 1. Characterization of the resulting honeycombs was also according to the techniques outlined above for Example 1, with results listed in Tables 2, 3A and 3B.

### Example 14

According to this example, a precursor batch was prepared by mixing the following constituents: 26.40 wt. % Mo powder, 43.44 wt. % Si powder, 7 wt. % MM1-hydroxypropyl methylcellulose A4M and 1 wt % sodium stearate (LIGA SS3 SG3 sodium stearate from Peter Greven GmbH & Co.) in a polyethylene jar. Following this step, 25.16 wt. % phenolic resin (GP® 510D50 from Georgia Pacific Chemicals) was added to the mixture and mixed in a separate polyethylene jar. Accordingly, the mole fraction ratio of Mo:Si:C for this precursor batch was 0.108:0.605:0.287, as shown below in Tables 2, 3A and 3B. Further, the resulting precursor was converted into a conductive ceramic honeycomb according to the method outlined above for Example 1. Characterization of the resulting honeycombs was also according to the techniques outlined above for Example 1, with results listed in Tables 2, 3A and 3B.

### Example 15

According to this example, a precursor batch was prepared by mixing the following constituents: 36.71 wt. % Mo powder, 36.43 wt. % Si powder, 7 wt. % MM1-hydroxypropyl methylcellulose A4M, 1 wt % sodium stearate (LIGA SS3 SG3 sodium stearate from Peter Greven GmbH & Co.) and 5 wt. % polyethylene beads (Microthene FN51000 20 μm particle size PE beads from LyondellBasell Industries Holdings B.V.) in a polyethylene jar. Following this step, 13.86 wt. % phenolic resin (GP® 510D50 from Georgia Pacific Chemicals) was added to the mixture and mixed in a separate polyethylene jar. Accordingly, the mole fraction ratio of Mo:Si:C for this precursor batch was 0.184:0.622:0.194, as shown below in Tables 2, 3A and 3B. Further, the resulting precursor was converted into a conductive ceramic honeycomb according to the method outlined above for Example 1. Characterization of the resulting honeycombs was also according to the techniques outlined above for Example 1, with results listed in Tables 2, 3A and 3B.

### Example 16

According to this example, a precursor batch was prepared by mixing the following constituents: 38.40 wt. % Mo powder, 34.10 wt. % Si powder, 7 wt. % MM1-hydroxypropyl methylcellulose A4M, 1 wt % sodium stearate (LIGA SS3 SG3 sodium stearate from Peter Greven GmbH & Co.) and 5 wt. % polyethylene beads (Microthene FN51000 20 μm particle size PE beads from LyondellBasell Industries Holdings B.V.) in a polyethylene jar. Following this step, 14.5 wt. % phenolic resin (GP® 510D50 from Georgia Pacific Chemicals) was added to the mixture and mixed in a separate polyethylene jar. Accordingly, the mole fraction ratio of Mo:Si:C for this precursor batch was 0.196:0.596:0.207, as shown below in Tables 2, 3A and 3B. Further, the resulting precursor was converted into a conductive ceramic honeycomb according to the method outlined above for Example 1. Characterization of the resulting honeycombs was also according to the techniques outlined above for Example 1, with results listed in Tables 2, 3A and 3B.

### Example 17

According to this example, a precursor batch was prepared by mixing the following constituents: 20.60 wt. % Mo powder, 36.52 wt. % Si powder, 7 wt. % MM1-hydroxypropyl methylcellulose A4M, 1 wt % sodium stearate (LIGA SS3 SG3 sodium stearate from Peter Greven GmbH & Co.) and 5 wt. % polyethylene beads (Microthene FN51000 20 μm particle size PE beads from LyondellBasell Industries Holdings B.V.) in a polyethylene jar. Following this step, 29.88 wt. % phenolic resin (GP® 510D50 from Georgia Pacific Chemicals) was added to the mixture and mixed in a separate polyethylene jar. Accordingly, the mole fraction ratio of Mo:Si:C for this precursor batch was 0.090:0.545:0.365, as shown below in Tables 2, 3A and 3B. Further, the resulting precursor was converted into a conductive ceramic honeycomb according to the method outlined above for Example 1. Characterization of the resulting honeycombs was also according to the techniques outlined above for Example 1, with results listed in Tables 2, 3A and 3B.

### Example 18

According to this example, a precursor batch was prepared by mixing the following constituents: 28.2 wt. % Ti powder, 47.4 wt. % Si powder, 6 wt. % MM1-hydroxypropyl methylcellulose A4M and 1 wt % sodium stearate (LIGA SS3 SG3 sodium stearate from Peter Greven GmbH & Co.) in a polyethylene jar. Following this step, 17.5 wt. % phenolic resin (GP® 510D50 from Georgia Pacific Chemicals) was added to the mixture and mixed in a separate polyethylene jar. Accordingly, the mole fraction ratio of Ti:Si:C for this precursor batch was 0.200:0.610:0.190, as shown below in Tables 2, 3A and 3B. Further, the resulting precursor was converted into a conductive ceramic honeycomb according to the method outlined above for Example 1. Characterization of the resulting honeycombs was also according to the techniques outlined above for Example 1, with results listed in Tables 2, 3A and 3B.

### Example 19

According to this example, a precursor batch was prepared by mixing the following constituents: 46.3 wt. % Ti powder, 34.4 wt. % Si powder, 6 wt. % MM1-hydroxypropyl methylcellulose A4M and 1 wt % sodium stearate (LIGA SS3 SG3 sodium stearate from Peter Greven GmbH & Co.) in a polyethylene jar. Following this step, 12.2 wt. % phenolic resin (GP® 510D50 from Georgia Pacific Chemicals) was added to the mixture and mixed in a separate polyethylene jar. Accordingly, the mole fraction ratio of Ti:Si:C for this precursor batch was 0.380:0.480:0.140, as shown below in Tables 2, 3A and 3B. Further, the resulting precursor was converted into a conductive ceramic honeycomb according to the method outlined above for Example 1. Characterization of the resulting honeycombs was also according to the techniques outlined above for Example 1, with results listed in Tables 2, 3A and 3B.

TABLE 2
Physical and Electrical Properties of Conductive Ceramic Honeycombs

| | Examples | | | | | | | | | |
|---|---|---|---|---|---|---|---|---|---|---|
| | Ex. 1 | Ex. 2 | Ex.3 | Ex. 4 | Ex. 5 | Ex. 6 | Ex. 7 | Ex. 8 | Ex. 9 | |
| Mo:Si:C | 0.085: | 0.094: | 0.104: | 0.113: | 0.122: | 0.132: | 0.141: | 0.150: | 0.159: | |
| | 0.570: | 0.576: | 0.581: | 0.586: | 0.591: | 0.596: | 0.601: | 0.606: | 0.611: | |
| | 0.344 | 0.330 | 0.316 | 0.301 | 0.287 | 0.272 | 0.258 | 0.244 | 0.215 | |
| Ti:Si:C | *** | *** | *** | *** | *** | *** | *** | *** | *** | |
| Conductivity (S/cm) | 13.67 | 37.58 | 73.00 | 108.75 | 273.94 | 539.34 | 635.28 | 1033.93 | 1432.41 | |
| Skeletal density (g/cc) | 4.5 | 4.9 | 4.5 | 4.9 | 4.5 | 4.9 | 4.5 | 4.9 | 4.5 | |
| Pore size (μm) | 6.10 | 7.02 | 6.19 | 6.45 | 6.39 | 5.80 | 6.49 | 6.29 | 6.84 | |
| Porosity (%) | 66.41 | 62.83 | 59.04 | 57.80 | 57.06 | 56.47 | 57.08 | 59.09 | 55.84 | |
| Pore volume (ml/g) | 0.486 | 0.405 | 0.336 | 0.325 | 0.295 | 0.287 | 0.285 | 0.291 | 0.259 | |
| | Examples | | | | | | | | | |
| | Ex. 10 | Ex. 11 | Ex. 12 | Ex. 13 | Ex. 14 | Ex. 15 | Ex. 16 | Ex. 17 | Ex. 18 | Ex. 19 |
| Mo:Si:C | 0.169: | 0.184: | 0.182 | 0.111: | 0.108: | 0.184: | 0.196: | 0.090: | *** | *** |
| | 0.616: | 0.622: | 0.627: | 0.595: | 0.605: | 0.622: | 0.596: | 0.545: | | |
| | 0.215 | 0.194 | 0.192 | 0.295 | 0.287 | 0.194 | 0.207 | 0.365 | | |
| Ti:Si:C | *** | *** | *** | *** | *** | *** | *** | *** | 0.200: | 0.380 |
| | | | | | | | | | 0.610: | 0.480: |
| | | | | | | | | | 0.190 | 0.140 |
| Conductivity | 1747.34 | 2485.57 | 3227.74 | 109.47 | 88.56 | 1940.65 | 2457.29 | 2.44 | 337.34 | 1391.28 |
| (S/cm) | | | | | | | | | | |
| Skeletal | 4.9 | 4.9 | 4.2 | 4.38 | 4.38 | 5.1 | 5.1 | 4.4 | 3.8 | 3.8 |
| density (g/cc) | | | | | | | | | | |
| Pore size | 6.66 | 7.08 | 8.17 | 9.87 | 9.7 | 9.08 | 6.02 | 6.66 | 1.44 | 3.76 |
| (μm) | | | | | | | | | | |
| Porosity (%) | 56.48 | 52.36 | 46.42 | 57.65 | 57.43 | 57.21 | 54.14 | 66.26 | 55.21 | 57.77 |
| Pore volume | 0.260 | 0.224 | 0.185 | 0.306 | 0.312 | 0.267 | 0.229 | 0.455 | 0.324 | 0.360 |
| (ml/g) | | | | | | | | | | |

TABLE 3A
XRD Characterization of Conductive Ceramic Honeycombs

| | | | | Hex | Tet |
|---|---|---|---|---|---|
| | | MoSi₂ | SiC | Mo₅Si₃ | Mo₅Si₃ |
| | | wt % | wt % | wt % | wt % |
| | Compositions | from | from | from | from |
| Example # | (see Table 2) | XRD | XRD | XRD | XRD |
| Ex. 1 | Mo0.085Si0.570C0.344 | 24 | 70 | 6 | 0 |
| Ex. 2 | Mo0.094Si0.576C0.330 | 28 | 68 | 4.2 | 0.3 |
| Ex. 3 | Mo0.104Si0.581C0.316 | 33 | 63 | 4.4 | 0 |
| Ex. 4 | Mo0.113Si0.586C0.301 | 34 | 62 | 4.1 | 0.3 |
| Ex. 5 | Mo0.122Si0.591C0.287 | 39 | 57 | 4.2 | 0 |
| Ex. 6 | Mo0.132Si0.596C0.272 | 38 | 57 | 4.4 | 0.3 |
| Ex. 7 | Mo0.141Si0.601C0.258 | 44 | 52 | 3.9 | 0 |
| Ex. 8 | Mo0.150Si0.606C0.244 | 45 | 51 | 3.7 | 0.3 |
| Ex. 9 | Mo0.159Si0.611C0.230 | 45 | 48 | 7 | 0 |
| Ex. 10 | Mo0.169Si0.616C0.215 | 49 | 46 | 4.8 | 0 |
| Ex. 11 | Mo0.184Si0.622C0.194 | 53 | 41 | 5.8 | 0.3 |
| Ex. 12 | Mo0.182Si0.627C0.192 | 57 | 40 | 3.2 | 0 |
| Ex. 13 | Mo0.111Si0.595C0.295 | 32 | 61 | 6.9 | 0 |
| Ex. 14 | Mo0.108Si0.605C0.287 | 29 | 63 | 8.6 | 0 |
| Ex. 15 | Mo0.184Si0.622C0.194 | 55 | 40 | 4.5 | 0 |
| Ex. 16 | Mo0.196Si0.596C0.207 | 43 | 39 | 18 | 0 |
| Ex. 17 | Mo0.090Si0.545C0.365 | 27.7 | 65 | 7 | 0 |

TABLE 3B
Characterization of Conductive Ceramic Honeycombs based on XRD Data

| | | | | | Total | Total |
|---|---|---|---|---|---|---|
| | Compositions | MoSi₂ | Mo₅Si₃ | SiC | Silicides | Carbides |
| Example | (see Table 2) | volume % | volume % | volume % | (Volume %) | (Volume %) |
| Ex. 1 | Mo0.085Si0.570C0.344 | 14.54 | 2.77 | 82.69 | 17.31 | 82.69 |
| Ex. 2 | Mo0.094Si0.576C0.330 | 17.07 | 2.09 | 80.84 | 19.16 | 80.84 |
| Ex. 3 | Mo0.104Si0.581C0.316 | 20.73 | 2.11 | 77.16 | 22.84 | 77.16 |
| Ex. 4 | Mo0.113Si0.586C0.301 | 21.48 | 2.12 | 76.40 | 23.60 | 76.40 |
| Ex. 5 | Mo0.122Si0.591C0.287 | 25.43 | 2.09 | 72.48 | 27.52 | 72.48 |
| Ex. 6 | Mo0.132Si0.596C0.272 | 24.88 | 2.35 | 72.77 | 27.23 | 72.77 |
| Ex. 7 | Mo0.141Si0.601C0.258 | 29.65 | 2.01 | 68.34 | 31.66 | 68.34 |
| Ex. 8 | Mo0.150Si0.606C0.244 | 30.51 | 2.07 | 67.42 | 32.58 | 67.42 |
| Ex. 9 | Mo0.159Si0.611C0.230 | 31.26 | 3.71 | 65.03 | 34.97 | 65.03 |
| Ex. 10 | Mo0.169Si0.616C0.215 | 34.42 | 2.57 | 63.01 | 36.99 | 63.01 |
| Ex. 11 | Mo0.184Si0.622C0.194 | 38.51 | 3.38 | 58.10 | 41.90 | 58.10 |
| Ex. 12 | Mo0.182Si0.627C0.192 | 41.47 | 1.78 | 56.75 | 43.25 | 56.75 |
| Ex. 13 | Mo0.111Si0.595C0.295 | 20.48 | 3.37 | 76.15 | 23.85 | 76.15 |
| Ex. 14 | Mo0.108Si0.605C0.287 | 18.31 | 4.14 | 77.55 | 22.45 | 77.55 |
| Ex. 15 | Mo0.184Si0.622C0.194 | 40.31 | 2.52 | 57.17 | 42.83 | 57.17 |
| Ex. 16 | Mo0.196Si0.596C0.207 | 32.38 | 10.35 | 57.27 | 42.73 | 57.27 |
| Ex. 17 | Mo0.090Si0.545C0.365 | 17.33 | 3.34 | 79.32 | 20.68 | 79.32 |

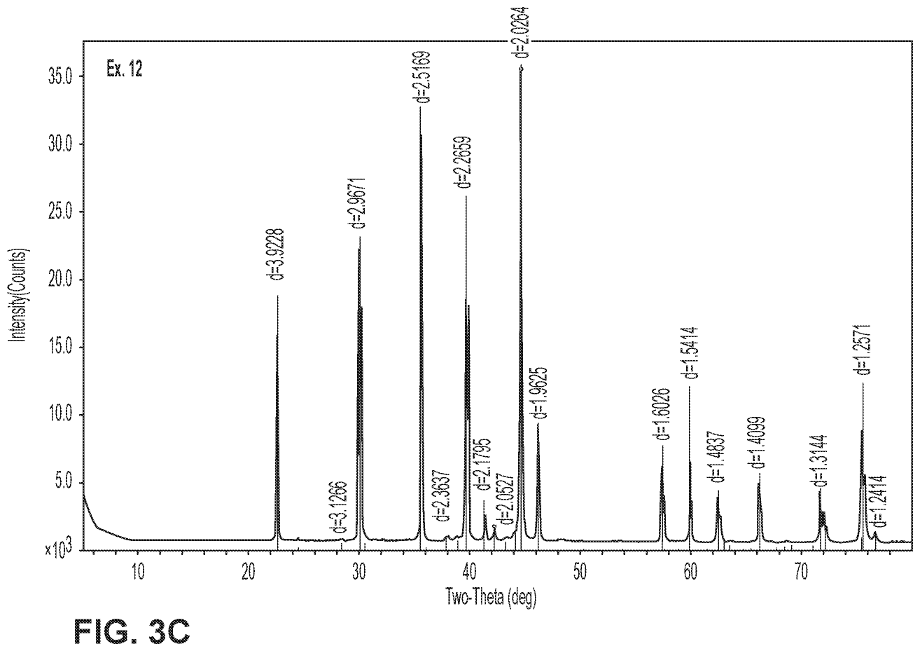

Referring now to FIGS. 3A-3C, x-ray diffraction (XRD) plots of exemplary conductive ceramic honeycomb compositions from Exs. 1, 4 and 12 are provided. As noted above in the descriptions of these examples, each of these conductive honeycomb compositions contains Mo, C and Si. As is evident from the XRD plots in FIGS. 3A-3C, the conductive ceramic honeycombs of Exs. 1, 4 and 12 each possess MoSi₂, Mo₅Si₃ and SiC phases.

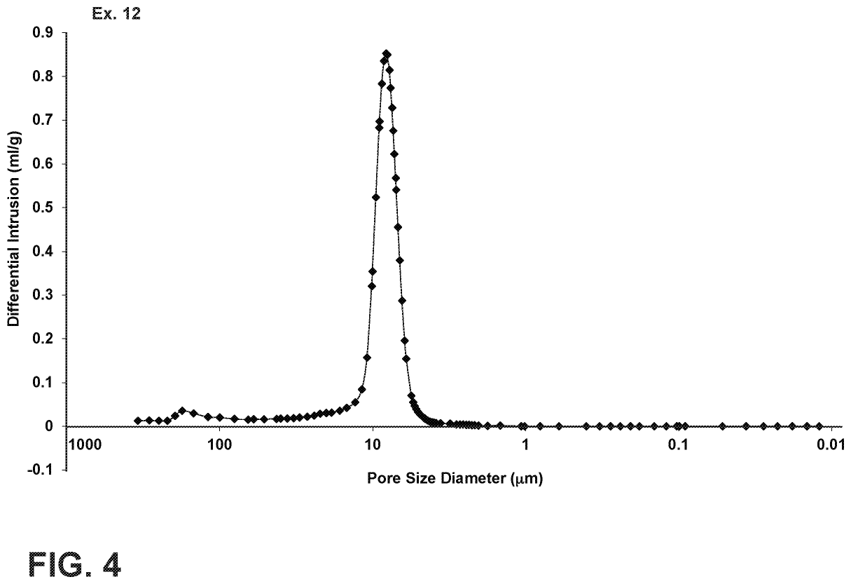

Referring to FIG. 4, a plot of pore size distribution (μm) of a conductive ceramic honeycomb composition from Ex. 12 is provided, as obtained through mercury porosimetry measurement techniques. As is evident from FIG. 4, the pore sizes of the conductive ceramic honeycomb of Ex. 12 ranges from about 5 μm to about 11 μm, with the peak of the distribution at about 8 μm (see also Table 2 above).

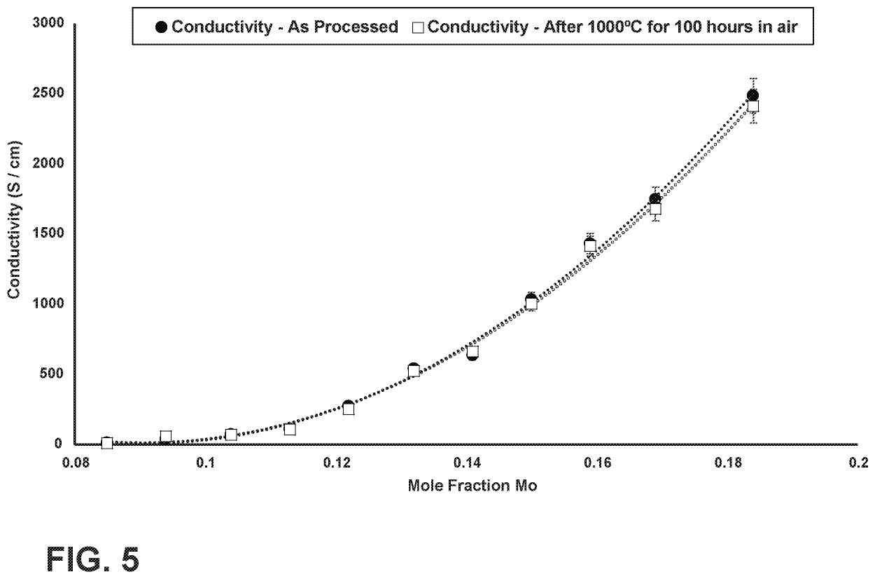

Referring now to FIG. 5, a plot of electrical conductivity (S/cm) vs. mole fraction of molybdenum for exemplary conductive ceramic compositions comprising molybdenum metal powder, silicon metal powder and carbon precursors is provided. Further, two data series are shown in FIG. 5: (a) the conductive ceramic compositions as prepared and (b) the conductive ceramic compositions after 100 hours of exposure to air at 1000° C. As is evident from the data in FIG. 5, increasing the mole fraction of molybdenum metal powder tends to result in an increase in the electrical conductivity of the resulting conductive ceramic composite. For example, mole fractions of Mo exceeding 0.16 resulted in ceramic composites having an electrical conductivity of about 1400 S/cm or greater. Further, the data shown in FIG. 5 demonstrates that these molybdenum-containing conductive ceramic composites prepared according to the methods of the disclosure retain their electrical conductivity after a significant exposure to a high-temperature, oxidative environment, i.e., 100 hours in air at 1000° C.

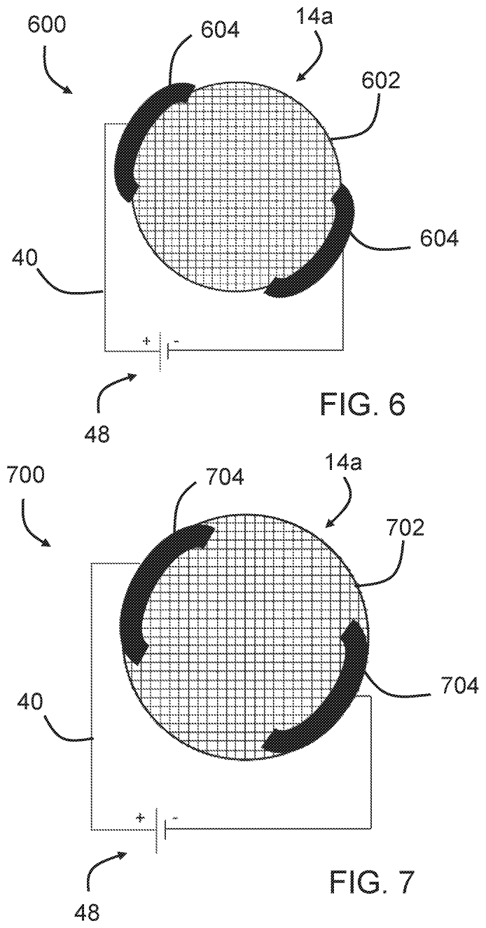

The conductive ceramic materials disclosed herein can be formed into heating elements having a various of shapes. For example, FIG. 6 illustrates an aftertreatment system 600 (e.g., for catalytic remediation or other treatment of a flow of fluid, e.g., exhaust from the engine of a vehicle) in which the conductive ceramic composite 14a is formed into a honeycomb body 602 having a cylindrical peripheral shape (as opposed to the peripherally square shape shown, e.g., in FIGS. 1-1C). The honeycomb body 602 comprises a honeycomb structure comprising a matrix of intersecting walls and cells, akin to the cells 16 and walls 18 of honeycomb body 10. To apply a voltage across the body 602, and therefore generate heat in the walls of the body 602 (e.g., as described above with respect to the aftertreatment system 15), the treatment system 600 comprises electrodes 604, which are coupled via the leads 40 to the power source 48.

FIG. 7 illustrates an aftertreatment system 700 (e.g., for catalytic remediation or other treatment of a flow of fluid, e.g., exhaust from the engine of a vehicle) in which the conductive ceramic composite 14a is formed into a honeycomb body 702 having a cylindrical peripheral shape, similar to the honeycomb body 602 of FIG. 6. The honeycomb body 702 comprises a honeycomb structure comprising a matrix of intersecting walls and cells, akin to the cells 16 and walls 18 of honeycomb body 10. To apply a voltage across the body 702, and therefore generate heat in the walls of the body 702 (e.g., as described above with respect to the aftertreatment system 15), the aftertreatment system 700 comprises electrodes 704, which are coupled via the leads 40 to the power source 48. In contrast to the aftertreatment system 600, the electrodes 704 of the aftertreatment system 700 are embedded into the sides of the honeycomb body 702 to further facilitate electrical conduction between the walls of the honeycomb body 702 and the electrodes 704.

FIG. 8 illustrates an aftertreatment system 800 (e.g., for catalytic remediation or other treatment of a flow of fluid, e.g., exhaust from the engine of a vehicle) in which the conductive ceramic composite 14a is formed into a honeycomb body 802 having a generally cylindrical peripheral shape, similar to the honeycomb bodies 602 and 702 of FIGS. 6 and 7. The honeycomb body 802 comprises a honeycomb structure comprising a matrix of intersecting walls and cells, akin to the cells 16 and walls 18 of honeycomb body 10. To apply a voltage across the body 802, and therefore generate heat in the walls of the body 802 (e.g., as described above with respect to the aftertreatment system 15), the aftertreatment system 800 comprises electrodes 804, which are coupled via the leads 40 to the power source 48. In contrast to the honeycomb bodies 602 and 702, the honeycomb body 802 comprises tapered protrusions 806 that extend laterally outward, and which tapered protrusions 806 are engaged with the electrodes 804. For example, the use of the tapered protrusions may be useful in reducing the size of the electrodes 804, and/or to set a preferred shape for the electrodes (e.g., flat plates) as opposed to electrodes that are curved for circumferential engagement with a rounded honeycomb body (as shown in FIG. 6), or embedded into a rounded honeycomb body (as shown in FIG. 7).

FIG. 9 illustrates an aftertreatment system 900 (e.g., for catalytic remediation or other treatment of a flow of fluid, e.g., exhaust from the engine of a vehicle) in which the conductive ceramic composite 14a is formed into a honeycomb body 902. The honeycomb body 902 comprises a honeycomb structure comprising a matrix of intersecting walls and cells, akin to the cells 16 and walls 18 of honeycomb body 10. To apply a voltage across the body 902, and therefore generate heat in the walls of the body 902 (e.g., as described above with respect to the aftertreatment system 15), the aftertreatment system 900 comprises electrodes 904, which are coupled via the leads 40 to the power source 48. In contrast to the honeycomb bodies 602 and 702, the honeycomb body 802 has cross-sectional shape that resembles a circle that has been truncated and flattened by removing portions from opposite sides. For example, similar to the embodiment of FIG. 8, the arrangement of FIG. 9 may be advantageous to set a preferred shape for the electrodes 904, (e.g., flat plates) as opposed to electrodes that are curved for circumferential engagement with a rounded honeycomb body (as shown in FIG. 6), or embedded into a rounded honeycomb body (as shown in FIG. 7).

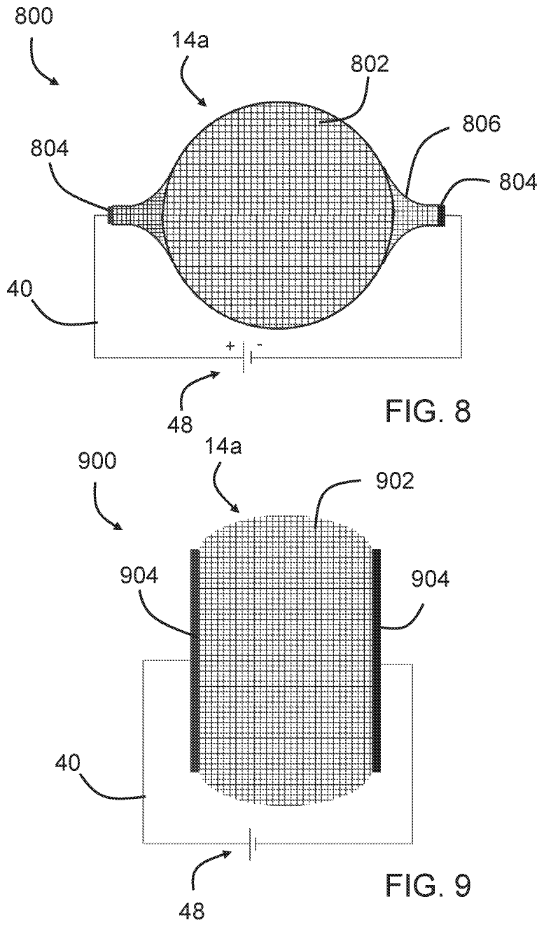

FIGS. 10A-10B illustrate an aftertreatment system 1000 (e.g., for catalytic remediation or other treatment of a flow of fluid, e.g., exhaust from the engine of a vehicle) in which the conductive ceramic composite 14a is formed into a honeycomb body 1002. The honeycomb body 1002 comprises a honeycomb structure comprising a matrix of intersecting walls and cells, akin to the cells 16 and walls 18 of honeycomb body 10. To apply a voltage across the body 1002, and therefore generate heat in the walls of the body 1002 (e.g., as described above with respect to the aftertreatment system 15), the aftertreatment system 1000 comprises electrodes 1004, which are coupled via the leads 40 to the power source 48. In contrast to the honeycomb bodies 602, 802, and 902, the electrodes 1004 are embedded in the honeycomb body 1002. In contrast to the honeycomb body 702, the electrodes 1004 are each embedded in individual ones of the cells of the honeycomb body 1004. For example, the electrodes 1004 can be shaped and sized to fit into one of the cells, and/or the electrodes 1004 can be held in place by an adhesive, such as a conductive cement or other material (e.g., conductive ceramic, conductive polymer, metal, or composite thereof). Three pairs of the electrodes 1004 are shown in FIG. 10A, however, any number of electrodes can be utilized.

FIG. 10B shows a side view of the aftertreatment system 1000 to illustrate how the electrodes 1004 can be secured into the honeycomb body 1002. For example, a first one of the electrodes 1004, designated with reference numeral 1004a, is arranged such that an embedded portion 1006 of the electrode 1004 is inserted into the honeycomb body 1002 with respect to the axial direction of the honeycomb body 1002. In other words, the electrode 1004a is inserted into one of the cells of the honeycomb body 1002 from one of the end faces of the honeycomb body 1002 (i.e., the inlet face or the outlet face). A second one of the electrodes 1004, designated as electrode 1004b, is arranged such that an embedded portion 1008 of the electrode 1004b is inserted through the outer periphery of the honeycomb body 1002 in a direction transverse to the axial direction of the honeycomb body 1002, e.g., in the radial direction if the honeycomb body 1002 has a circular cross-sectional shape. Thus, the electrodes 1004 can be inserted in any combination of axial and/or transverse directions, as shown.

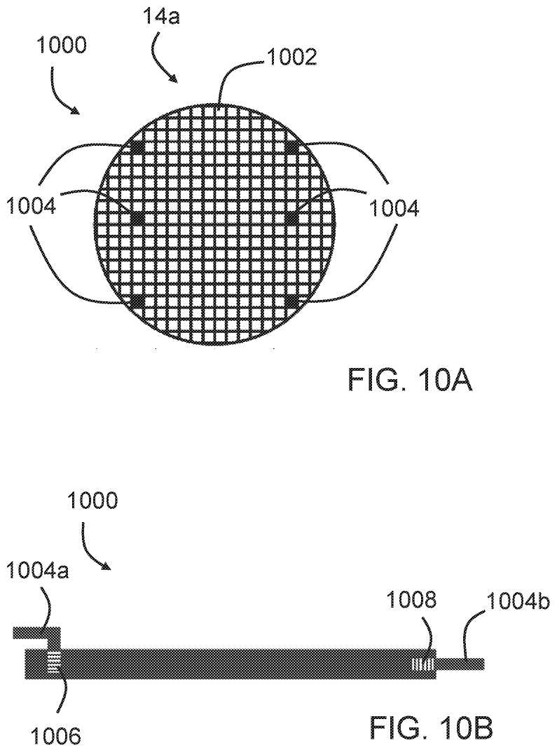

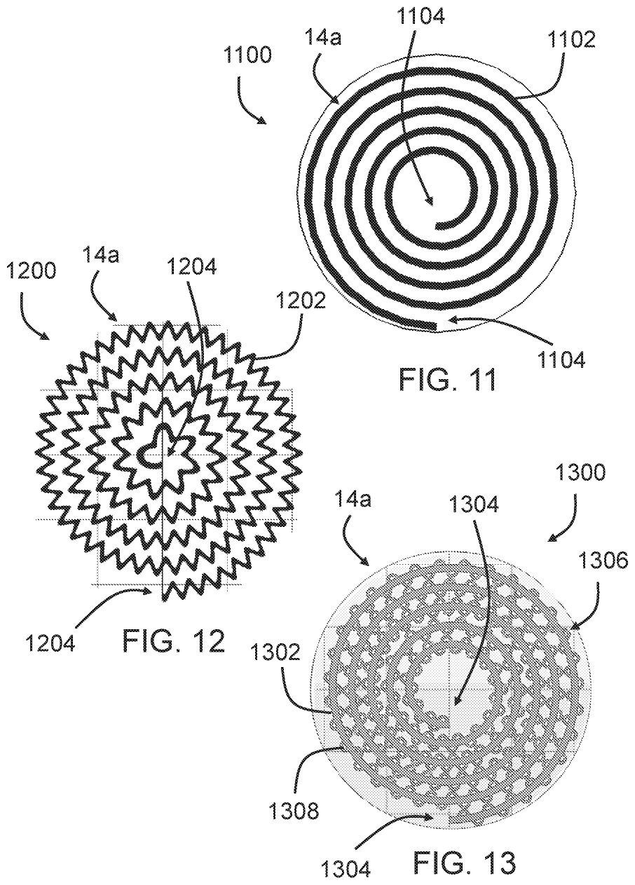

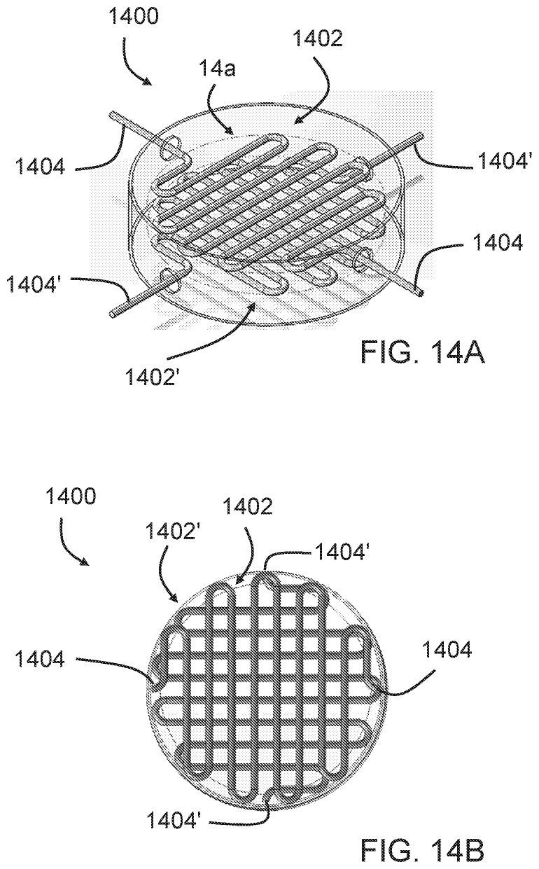

The conductive ceramic composite material 14a disclosed herein can also be arranged in non-honeycomb configurations. For example, FIGS. 11-13 illustrate various embodiments in which a ceramic body comprising the conductive ceramic composite material 14a formed with a a ceramic body having a spiral or winding shape, while FIGS. 14A-14B illustrate a ceramic body having a serpentine shape. Since the embodiments of FIGS. 11-14B also comprise the conductive ceramic composite material 14a, the description of the conductive ceramic material 14a given above, such as the properties (e.g., conductivity, porosity, etc.), composition (e.g., silicide phase(s) and carbide phase(s)), method of manufacturing, and so on, are also applicable to FIGS. 11-14B.

FIG. 11 shows an aftertreatment device 1100 that comprises the conductive ceramic composite material 14a formed into a spiral body 1102. In this arrangement, opposite ends 1104 of the spiral body can be electrically coupled to an electrical power source, e.g., the power source 48 via the leads 40, in order to generate resistive heating within the spiral body 1102. FIG. 12 illustrates an aftertreatment system 1200 comprising the conductive ceramic composite material 14a formed into a spiral body 1202 and FIG. 13 illustrates an aftertreatment system 1300 comprising the conductive ceramic composite material 14a formed into a spiral body 1302. Similar to the opposite ends 1104 of FIG. 11, the opposite ends 1204 of spiral body 1202 and opposite ends 1304 of spiral body 1302 can be electrically coupled to an electrical power source, e.g., the power source 48 via the leads 40, in order to generate resistive heating within the spiral body 1202, 1302. In contrast to the spiral body 1102, the spiral bodies 1202, 1302 are arranged to provide increased surface area, e.g., to carry more catalytic material and/or to increase the rate of heat transfer between the ceramic bodies 1202, 1302 and a fluid stream, e.g., vehicle engine exhaust. For example, the ceramic spiral body 1202 is arranged so that it is wavy, sinuous, and/or corrugated, while the ceramic spiral body 1302 comprises a surface texture comprising a plurality of projections 1306 extending outwardly from the sides of the spiral body 1302 along its length between the opposite ends 1304. The projections 1306 in FIG. 13 form pockets 1308 (which further increase surface area without significantly increasing thermal mass), but can alternatively be formed as solid protrusions without such pockets 1308.

FIGS. 14A-14B illustrate an aftertreatment system 1400 in which the conductive ceramic composite material 14a is arranged in a ceramic body 1402 having a serpentine shape. Opposite ends 1404 of the serpentine body 1402 can be electrically coupled to a power source, e.g., the power source 48, for generating resistive heating in the material of the serpentine body 1402. The system 1402 can be arranged with a single one of the serpentine bodies 1402, however, in the embodiment of FIGS. 14A-14B, a second ceramic serpentine body, designated with reference numeral 1402′, and generally resembling the first ceramic serpentine body 1402, is also included. In addition to providing a secondary source of heat generation, the second ceramic serpentine body 1402′ in the illustrated embodiment is rotated with respect to the first serpentine body 1402 (e.g., by 90°) to increase the surface area and/or tortuosity of the flow path through the system 1400, thereby increasing heat transfer with the fluid stream through the system 1400. Any number of serpentine bodies can be sequentially arranged along the fluid flow path to further increase heat generation and surface area for effective heat transfer.

Non-honeycomb shapes, such as disclosed in FIGS. 11-14B, can be utilized to facilitate electrical coupling between the corresponding conductive ceramic body and a power source. For example, as described above with respect to the honeycomb bodies of FIGS. 1-1C, and 6-10B, the honeycomb body must be configured to accommodate attachment to and/or engagement with a pair of electrodes to provide the voltage necessary for generating heat. Advantageously, the non-honeycomb shapes can be configured to alleviate the need to attach such electrodes, e.g., the respective opposite ends 1104, 1204, 1304, and 1404 can effectively act as, and/or integrally form, electrodes for electrically coupling to a power source, such as the power source 48.

As outlined herein, a first aspect of disclosure pertains to an electrically conductive honeycomb body. The honeycomb body comprises a porous honeycomb structure comprising a plurality of intersecting porous walls arranged to provide a matrix of cells, the porous walls comprising wall surfaces that define a plurality of channels extending from an inlet end to an outlet end of the structure. The porous walls are comprised of a ceramic composite material that comprises at least one carbide phase and at least one silicide phase, each carbide and silicide phase comprising one or more metals selected from the group consisting of Si, Mo, Ti, Zr and W.

According to a second aspect, the first aspect is provided, wherein the porous walls have an electrical conductivity from about 1 S/cm to about 5000 S/cm.

According to a third aspect, the first or second aspect is provided, wherein the porous walls comprises a median pore size from about 1 μm to about 10 μm.

According to a fourth aspect, any of the first through third aspects is provided, wherein the porous walls comprise a median porosity from about 35% to about 70%.

According to a fifth aspect, any of the first through fourth aspects is provided, wherein the porous walls comprise a median pore volume from about 0.1 ml/g to about 0.5 ml/g.

According to a sixth aspect, any of the first through fifth aspects is provided, wherein the porous walls comprise less than about 0.5 wt % of free silicon metal.

According to a seventh aspect, any of the first through sixth aspects is provided, wherein the porous walls comprise essentially no free silicon metal.

According to an eighth aspect, any of the first through seventh aspects is provided, wherein the porous walls comprise less than about 0.5 wt % of free metal.

According to a ninth aspect, any of the first through eighth aspects is provided, wherein the porous walls comprise essentially no free metal.

According to a tenth aspect, any of the first through ninth aspects is provided, wherein the at least one carbide phase is SiC, and the at least one silicide phase is MoSi₂ and Mo₅Si₃.

According to an eleventh aspect, any of the first through tenth aspects is provided, wherein a volume fraction of the at least one carbide phase is from about 45% to about 90% and a volume fraction of the at least one silicide is from about 10% to about 55%, and further wherein the total of the volume fractions of the at least one carbide and the at least one silicide is about 100%.

According to a twelfth aspect, any one of the first through ninth aspects is provided, wherein the at least one silicide phase is a di-silicide and a tri-silicide.

According to a thirteenth aspect, any one of the first through ninth aspects is provided, wherein the at least one carbide phase is SiC, and the at least one silicide phase comprises titanium (Ti) silicide.

According to a fourteenth aspect, a method of making a conductive ceramic honeycomb is provided. The method comprises: mixing a plurality of ingredients together into a mixture, the ingredients comprising (a) a metal powder selected from the group consisting of Mo, Ti, Zr and W metal powder, (b) a silicon (Si) metal powder, (c) a carbon precursor and (d) a liquid vehicle; extruding the batch into a green honeycomb body; drying the green honeycomb body in air from about 50° C. to about 200° C.; carbonizing the green honeycomb body in an inert atmosphere from about 300° C. to about 900° C.; and firing the green honeycomb body in an inert atmosphere from about 1400° C. to about 1800° C. to form an electrically conductive honeycomb body, the honeycomb body comprising a porous honeycomb structure comprising a plurality of intersecting porous walls arranged to provide a matrix of cells, the porous walls comprising wall surfaces that define a plurality of channels extending from an inlet end to an outlet end of the structure. The porous walls are comprised of a ceramic composite material that comprises at least one carbide phase and at least one silicide phase, each carbide and silicide phase comprising one or more metals selected from the group consisting of Si, Mo, Ti, Zr and W.

According to a fifteenth aspect, the fourteenth aspect is provided, wherein the carbonizing step is conducted in a gaseous atmosphere comprising one or more of nitrogen, argon and helium, and further wherein the firing step is conducted in a gaseous atmosphere comprising one or more of argon and helium.

According to a sixteenth aspect, the fourteenth or the fifteenth aspect is provided, wherein the carbon precursor comprises a thermosetting polymer which is at least partially cured during the drying step.

According to a seventeenth aspect, any one of the fourteenth through the sixteenth aspects is provided, wherein the at least one carbide phase is SiC, and the at least one silicide phase is MoSi₂ and Mo₅Si₃.

According to an eighteenth aspect, any one of the fourteenth through the seventeenth aspects is provided, wherein a volume fraction of the at least one carbide phase is from about 45% to about 90% and a volume fraction of the at least one silicide is from about 10% to about 55%, and further wherein the total of the volume fractions of the at least one carbide and the at least one silicide is about 100%.

According to a nineteenth aspect, any one of the fourteenth through the eighteenth aspects is provided, wherein the at least one silicide phase is a di-silicide and a tri-silicide.

According to a twentieth aspect, any one of the fourteenth through the nineteenth aspects is provided, wherein the porous walls are substantially devoid of free silicon metal and have an electrical conductivity from about 1 S/cm to about 5000 S/cm.

According to a twenty-first aspect, any one of the fourteenth through the twentieth aspects is provided, wherein the mixture comprises (a) a mole fraction of the metal powder selected from the group consisting of Mo, Ti, Zr and W metal powder from about 0.05 to about 0.5, (b) a mole fraction of the silicon (Si) metal powder from about 0.4 to about 0.8 and (c) a mole fraction of the carbon (C) provided from the carbon precursor from about 0.1 to about 0.5.

According to a twenty-second aspect, any one of the fourteenth through the twenty-first aspects is provided, wherein the porous walls comprise a median pore size from about 1 μm to about 10 μm.

According to a twenty-third aspect, any one of the fourteenth through the twenty-second aspects is provided, wherein the porous walls comprise a median porosity from about 35% to about 70%.

Many variations and modifications may be made to the above-described embodiments of the disclosure without departing substantially from the spirit and various principles of the disclosure. All such modifications and variations are intended to be included herein within the scope of this disclosure and protected by the following claims.

1. An electrically conductive honeycomb body, comprising:
a porous honeycomb structure comprising a plurality of intersecting porous walls arranged to provide a matrix of cells, the porous walls comprising wall surfaces that define a plurality of channels extending from an inlet end to an outlet end of the structure,
wherein the porous walls are comprised of a ceramic composite material that comprises at least one carbide phase and at least one silicide phase, each carbide and silicide phase comprising one or more metal compounds, each metal compound comprising one or more of Si, Mo, Ti, Zr and W.

2. The honeycomb body according to claim 1, wherein the porous walls have an electrical conductivity from about 1 S/cm to about 5000 S/cm.

3. The honeycomb body according to claim 1, wherein the porous walls comprise a median pore size from about 1 μm to about 10 μm.

4. The honeycomb body according to claim 1, wherein the porous walls comprise a median porosity from about 35% to about 70%.

5. The honeycomb body according to claim 1, wherein the porous walls comprise less than about 0.5 wt % free silicon metal.

6. The honeycomb body according claim 1, wherein the porous walls comprise essentially no free silicon metal.

7. The honeycomb body according to claim 1, wherein the porous walls comprise less than about 0.5 wt % free metal.

8. The honeycomb body according to claim 1, wherein the porous walls comprise essentially no free metal.

9. The honeycomb body according to claim 1, wherein the at least one carbide phase comprises SiC, and the at least one silicide phase comprises MoSi₂ and Mo₅Si₃.

10. The honeycomb body according to claim 1, wherein a volume fraction of the at least one carbide phase is from about 45% to about 90% and a volume fraction of the at least one silicide is from about 10% to about 55%, and the total of the volume fractions of the at least one carbide phase and the at least one silicide phase is about 100%.

11. The honeycomb body according to claim 1, wherein the at least one silicide phase contains a di-silicide and a tri-silicide.

12. The honeycomb body according to claim 1, wherein the at least one carbide phase comprises SiC, and the at least one silicide phase comprises a titanium (Ti) silicide.

13. An aftertreatment system comprising the electrically conductive ceramic body of claim 1 and an aftertreatment device.

14. A method of making a conductive ceramic honeycomb, comprising:
mixing a plurality of ingredients together into a mixture, the ingredients comprising (a) a metal powder selected from the group consisting of Mo, Ti, Zr and W metal powder, (b) a silicon (Si) metal powder, (c) a carbon precursor, and (d) a liquid vehicle;
extruding the mixture into a green honeycomb body;
drying the green honeycomb body in air from about 50° C. to about 200° C.;
carbonizing the green honeycomb body in an inert atmosphere from about 300° C. to about 900° C.; and
firing the green honeycomb body in an inert atmosphere from about 1400° C. to about 1800° C. to form an electrically conductive honeycomb body, the honeycomb body comprising a porous honeycomb structure comprising a plurality of intersecting porous walls arranged to provide a matrix of cells, the porous walls comprising wall surfaces that define a plurality of channels extending from an inlet end to an outlet end of the structure,
wherein the porous walls are comprised of a ceramic composite material that comprises at least one carbide phase and at least one silicide phase, each carbide and silicide phase comprising one or more metals selected from the group consisting of Si, Mo, Ti, Zr and W.

15. The method according to claim 14, wherein the carbonizing step is conducted in a gaseous atmosphere comprising one or more of nitrogen, argon and helium, and further wherein the firing step is conducted in a gaseous atmosphere comprising one or more of argon and helium.

16. The method according to claim 14, wherein the carbon precursor comprises a thermosetting polymer which is at least partially cured during the drying step.

17-20. (canceled)

21. The method according to claim 14, wherein the mixture comprises (a) a mole fraction of the metal powder selected from the group consisting of Mo, Ti, Zr and W metal powder from about 0.05 to about 0.5, (b) a mole fraction of the silicon (Si) metal powder from about 0.4 to about 0.8 and (c) a mole fraction of the carbon (C) provided from the carbon precursor from about 0.1 to about 0.5.

22-23. (canceled)

24. An electrically conductive ceramic body, comprising:
a ceramic composite material that comprises at least one carbide phase and at least one silicide phase, each carbide and silicide phase comprising one or more metal compounds, each metal compound comprising one or more of Si, Mo, Ti, Zr and W.

25-35. (canceled)

36. The ceramic body according to claim 24, wherein the ceramic body has a spiral shape.

37. The ceramic body according to claim 24, wherein the ceramic body has a serpentine shape.

38-39. (canceled)
